(19) United States
(12) Patent Application Publication
(10) Pub. No.: US 2004/0116115 A1
(43) Pub. Date: Jun. 17, 2004

(54) Systems and methods for providing interactive guest resources

(76) Inventor: Lawrence R. Ertel, San Rafael, CA (US)

Correspondence Address: WINSTON & STRAWN, PATENT DEPARTMENT, 1400 L STREET, N.W., WASHINGTON, DC, 20005-3502, US

(21) Appl. No.: 10/729,554

(22) Filed: Dec. 5, 2003

Related U.S. Application Data
(60) Provisional application No. 60/431,557, filed on Dec. 6, 2002.

(51) Int. Cl. H04Q 7/20

(52) U.S. Cl. 455/426.2; 455/422.1; 455/445

(57) ABSTRACT

Systems and methods for providing interactive user resources are described. In an implementation, the method includes providing a wireless local area network (WLAN) including at least two access points that each provide at least a 300 foot radius of coverage located within a campus, and providing at least one resources database. Each user is provided with a unique identifier for use with a wireless device to access the resources database through the WLAN. Selectable content options are offered on a display screen of the wireless device to users. The method also includes receiving a request for data based on a selected content option transmitted from the wireless device by a user, and transmitting data from at least one resources database for display on the wireless device in response to the user request.

This application claims the benefit of co-pending U.S. Provisional Application No. 60/431,557 filed on Dec. 6, 2002, which is incorporated by reference herein.

### BACKGROUND ART

Today's traveler is faced with a number of conflicting demands while traveling and vacationing, namely to be in touch while away from the office or home.

In addition they have expectations of services and information available to them based on their everyday experiences interacting with computer software, handheld PDA's and internet based services that are generally beyond the ability of most resorts to provide owing to their technical complexity and cost to deploy. Deployment of this information and these services to the traveler via the local resort's infrastructure offers great benefits to traveler and resort alike and has the ability to change the travelers experience from being one of frustration and annoyance to one whereby the traveler has great control over the conflicting demands made of them and additionally has access to services and information in a way quite unique in the context of present day resort services.

Techniques for alleviating some of the deficiencies of known systems may involve the use of wireless local area network (“WLAN”) technology. To date, WLAN technology has primarily been used for or focused on supporting industrial activities such as warehouse tracking. Examples of WLANs and related technology are illustratively shown in “Wireless LANs, Implementing Interoperable Networks”, published by McMillan Technical Publishing, authored by Jim Geier, first edition published in 1999, which is hereby incorporated herein in its entirety. Presently, there are an increasing number of technical solutions for implementing consumer handheld personal computing or personal communications devices in WLANs. Software and/or hardware may be implemented with WLANs and consumer handheld personal computing or personal communications devices to enhance a user's travel experience. The present invention now provides additional enhancements in this area.

### SUMMARY OF THE INVENTION

The present invention now provides systems and methods for providing interactive user resources. In one embodiment, the method includes providing a wireless local area network (WLAN) including at least two access points that each provide at least a 300 foot radius of coverage located within a campus, and providing at least one resources database. Each user is provided with a unique identifier for use with a wireless device to access the resources database through the WLAN. Selectable content options are offered on a display screen of the wireless device to users. The method also includes receiving a request for data based on a selected content option transmitted from the wireless device by a user, and transmitting data from at least one resources database for display on the wireless device in response to the user request.

Another embodiment according to the invention is a computer program product stored on a computer readable medium for providing interactive user resources. The computer program includes instructions operable to cause a computer to offer selectable content options on a display screen of a wireless device over a wireless local area network (WLAN). In addition, the program includes instructions to receive and recognize a unique user identifier along with a request for data based on a selected content option transmitted from the wireless device by a user, and to transmit data from at least one resources database for display on the wireless device of the user in response to the user request.

In another beneficial embodiment, a method for providing interactive user resources includes providing a user with an authentication code for use with a wireless device. This technique also includes providing an authentication server that can be accessed by the wireless device and that can authenticate the authentication code, and downloading a thin client to the wireless device after the authentication code has been recognized which generates an user interface display that includes a plurality of selectable options representing the user resources.

In yet another embodiment according to the invention, a computer program product stored on a computer readable medium for providing interactive user resources includes instructions operable to cause a computer to provide a user with an authentication code for use with a wireless device for permitting access to an authentication server. Instructions are also included to cause the computer to download a thin client to the wireless device after the authentication code has been recognized which generates an user interface display that includes a plurality of selectable options representing the user resources.

The various features according to the invention and described herein solve the problems and drawbacks of existing systems and thus alleviate guest annoyance and frustration. Consequently, a traveler or guest of an accommodations provider who utilizes the system and methods for providing interactive guest resources of the present invention enjoys an enhanced experience.

### BRIEF DESCRIPTION OF THE DRAWINGS

Other aspects, purposes and advantages of the invention will become clear after reading the following description with reference to the attached drawings, in which:

FIG. 1 is a block diagram illustrating a wireless local area network (WLAN) for use in a system for providing interactive user resources according to the invention.

FIG. 2 is a block diagram showing a guest accommodations provider WLAN that may include high traffic areas and low traffic areas for use in a system according to the invention.

FIG. 3 is a block diagram of an example of a campus of a guest accommodations provider that includes indoor areas and outdoor areas.

FIG. 4 is a flowchart showing an implementation of a method for providing interactive guest services according to the invention.

FIG. 5 is a block diagram showing an implementation of a system for providing interactive guest services according to the invention that includes a common database.

FIG. 6 is a block diagram of another implementation of a system for providing interactive guest services according to the invention that includes a WLAN for a guest accommodations provider.

FIG. 7 is a flowchart showing another implementation of a method for providing interactive guest services using a WLAN according to the invention.

FIG. 8 is a flowchart showing another implementation of a method for providing interactive guest services according to the invention that permits a user to transact financial activity.

FIG. 9 is a flowchart showing an implementation of a technique for authenticating an user in an interactive guest services method according to the invention.

FIG. 10 is a flowchart showing an implementation of a technique for providing multimedia resources in an interactive guest services method according to the invention.

FIG. 11 is a flowchart showing an implementation of a technique for providing WLAN resources that are temporarily available based on the transient stay of a user according to the invention.

FIG. 12 is a flowchart showing an implementation of a technique for implementing a software shell to provide resources over a WLAN according to the invention.

FIG. 13 is a flowchart showing an implementation of a technique for providing two-way voice communications to support resources over a WLAN according to the invention.

FIG. 14 is a flowchart showing another implementation of a technique for implementing a platform on a WLAN to provide guest services according to the invention.

FIG. 15 is a flowchart showing a technique for integrating a WLAN in one or more guest services structures to permit free roaming within a campus according to the invention.

FIG. 16 is a block diagram illustrating an example of a navigation display screen including a plurality of options according to the invention.

FIG. 17 is a schematic block diagram illustrating the signaling and processing activity for registration of a new guest according to the invention.

FIG. 18 is a schematic block diagram illustrating an example of application architecture for providing interactive media resources according to the invention.

FIG. 19 is a schematic block diagram illustrating an example of application architecture for permitting user transactions according to the invention.

FIGS. 20-73 show examples of a display screen of a portable user device presenting user resources, their supporting options and/or information.

FIG. 74 is a flowchart of another embodiment of a method for providing interactive guest services according to the invention.

### DETAILED DESCRIPTION OF THE PREFERRED EMBODIMENTS

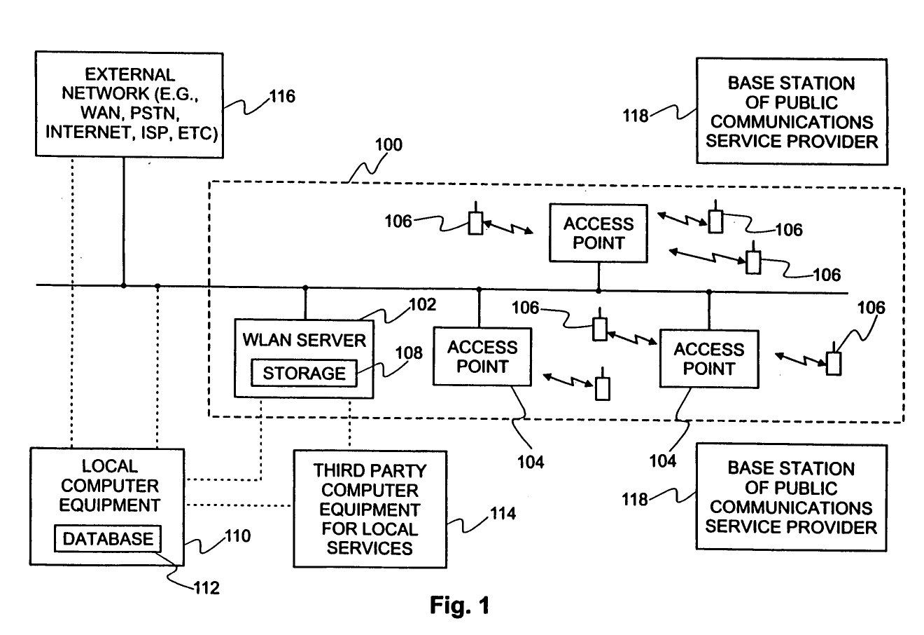

With reference now to FIG. 1, WLAN 100 may be implemented using for example, WLAN server 102, access points 104, portable guest terminals 106, and related supporting infrastructure (e.g., wired or wireless links connecting WLAN server 102 and access points 104). WLAN 100 may be implemented to provide WLAN communications coverage over all or a desired portion of a campus (i.e., a finite or controlled area within a building or the grounds) of an accommodations provider (e.g., a hotel, resort, cruise ship, etc.) and to provide guest services to guests of the accommodation provider. The invention is described below in the context of an accommodations provider, but it should be understood that such description is for illustrative purposes only, and that the term “guest” as used herein may mean a person staying in a hotel or resort, or a traveler, or a theme park visitor, or a convention attendee, or a gambler visiting a casino, or any other type of visitor or attendee.

Referring again to FIG. 1, the access points may be routers or other hardware devices capable of communicating with wireless devices, and may be connected to a WLAN server, external networks, local computer equipment, databases and the like. WLANs, WLAN servers, access point devices, portable terminals (e.g., portable WLAN communications devices such as Pocket PCs having a WLAN interface) are known to those skilled in the art. WLAN equipment vendors may provide servers, access points, and portable devices (or WLAN communication interfaces for portable devices) that are configured to provide WLAN communications using for example techniques specified in the IEEE 802.11 standard. Other WLAN communications standards or techniques may also be used. The purpose typically being to provide contention window based communications between access points and user terminals. Message traffic may be further managed using a WLAN server. Communications techniques using contention windows for WLANs are known to those skilled in the art. If desired, however, other communications between access points and terminals may also be implemented to provide communications. For example, each access point may provide coverage within approximately a 300 foot to 2,500 foot radius for communicating with portable guest terminals, but more or less coverage may be provided depending upon the specific campus or area to be covered. The range or the amount of area covered by an access point may depend on the type of equipment being used and/or on the power rating of an access point device.

WLAN server 102 may include storage 108 for storing database information, software applications, audiovisuals, graphics, promotional material, etc. WLAN server 102 may interface with local computer equipment 110 of the accommodation provider. Local computer equipment 110 may have an electronic interface with WLAN server 102 (e.g., via a network connection to WLAN 100 or via a separate communications connection such as a point-to-point communications connection). A human interface may be used to interface WLAN server 102 with local computer equipment 110. A combination of a human and electronic interface may also be used. Local computer equipment 110 may be used to carry out guest services that are selected by guests via WLAN 100. Local computer equipment 110 may for example include software and/or hardware for scheduling recreational activities, for placing food or drink orders, for scheduling transportation, etc. Further examples of services and resources are provided herein throughout. Local computer equipment 110 may include database 112 of guest services related information.

Software applications running on WLAN server 102 and user terminals 106 may provide guests with the ability to obtain services or information for the locality of the guest accommodations provider. Third party computer equipment 114 of local service providers may be implemented to provide services or information of the local service providers. Third party equipment 114 may communicate with WLAN server 102 or local computer equipment 110 to carry out request for services or information from third party providers. If desired a human interface may be used for interfacing third party equipment 114 with local computer equipment 110 or WLAN server 102.

WLAN 100 may include a communications connection with external network 116 such as a wide area network (e.g., the Internet), a public switched telephone network, etc. If desired, local computer equipment 110 and/or third party equipment 110 may have a communications connection with external network 116.

If desired, WLAN 100 may carry data, audio, video, or other forms of communications.

Base stations 118 may be base stations of a public wireless communications service provider. For example, base stations 118 may be cellular telephone base stations implementing TDMA, CDMA, GSM or other standard for public personal communications services. If desired, user terminals 106 may have hardware and/or software for operating within the wireless communications network of the public communications service provider. Such capability would be in addition to WLAN communications capabilities of user terminals 106. Also if desired, protocols for upper layers of the Open System Interconnect (“OSI”) model may be implemented to allow user terminals to interact with Internet Web sites. Such a feature would be provided in addition to providing WLAN software applications on WLAN 100 for providing guest services via user terminals 106. One aspect which is sought to be illustrated by the mention of base stations 118, is that if desired, WLAN guest resources may be separate from, independent of, unrelated to, or unassociated with base stations 118 and services supported by base stations 118 for a general geographic area that may include an accommodations provider, but is not exclusive to the accommodations provider. For example, a cellular network provided by the public personal communications provider may be independent of a WLAN of an accommodations provider. Similarly, if desired, in some aspects, WLAN guest resources may be provided to guests without requiring guests (or a proxy for the guests) to interact with an Internet Web site to provide WLAN guest resources (e.g., WLAN guest resources and supporting network may be independent of Internet Web site content). Lower layers of OSI (e.g., transport or network layers) may be implemented using for example TCP or IP in WLAN 100 to provide for desired functionality within WLAN 100. If desired, other techniques may also be employed.

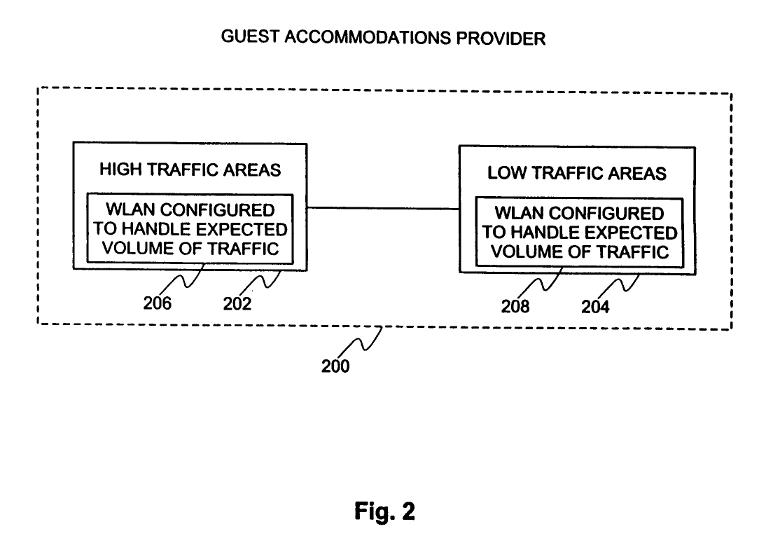

A WLAN may be configured to adapt to particular needs of guest accommodations providers, some of which may include a campus having outside grounds and several buildings. With reference now to FIG. 2, guest accommodations provider 200 may for example include high traffic areas 202 and low traffic areas 204. Examples of structures that may exist within the campus of a guest accommodation provider 200 may be buildings, guest rooms, restaurants, casinos, concert halls, swimming pools, areas for recreational water activities, recreational areas, sports facilities, restaurants, shops, spas, garage areas, that may each have different traffic (e.g., communication traffic). Examples of high traffic areas may include casinos, swimming pools, bars, restaurants, lobbies, etc. Examples of low traffic areas may include guest rooms, hallways, spas, garage or parking areas, outdoor walking paths, etc. WLAN 206 may be implemented within high traffic areas 202 and may be adapted to handle expected volume of traffic for high traffic areas 206. WLAN 208 may be implemented within low traffic areas 208 and may be adapted to handle expected volume of traffic for low traffic areas. Thus, a WLAN may be implemented that is adapted to meet communications needs of a guest accommodations provider such as a hotel, resort, cruise ship, etc. The system may integrate physical guest structures or services with a WLAN to provide an interactive electronic interface to centrally and conveniently provide physical services or information associated with the guest structures or services.

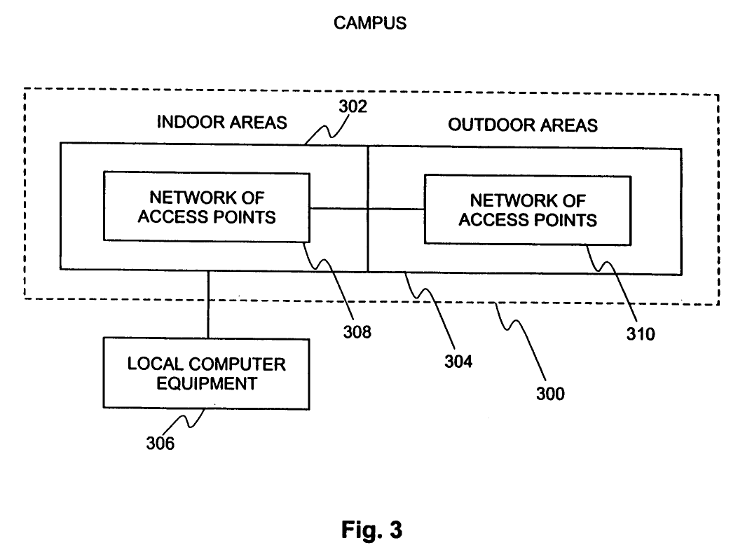

A campus or a guest accommodations provider may include indoor and outdoor facilities. A WLAN for providing features illustratively described herein may be implemented to provide services or content to guests when indoors or outdoors at a campus of an accommodations provider. With reference now to FIG. 3, campus 300 may be a campus of a guest accommodations provider. Campus 300 may include indoor areas 302 and outdoor areas 304. Network 308 of access points, that are suitable for indoor use, may be arranged to provide WLAN radio coverage for some, substantially all, or all of indoor area based at least partly on physical radio propagation characteristics of indoor WLAN radio communications. Network 310 of access points, that are adapted for outdoor use (e.g., adapted to operate within a wider range of environmental conditions), may be arranged to provide WLAN radio coverage for some, substantially all, or all of outdoor area 304 based at least partly on physical radio propagation characteristics of outdoor WLAN radio communications. For example, network 310 may provide coverage while guests are involved in water activities (e.g., in the ocean), involved in hiking, skiing, sun bathing, concerts, etc. Network 310 and network 308 may have communications connections and together may be part of a WLAN for the campus of a guest accommodations provider. Local computer equipment 306 may be the same as local computer equipment 110 of FIG. 1. Local computer equipment 306 may be local to campus 300 (e.g., positioned within campus 300). If desired, local computer equipment 306 may have a point-to-point or high speed communications connections with a WLAN for campus 300 to avoid latency issues that may arise when interfacing the WLAN and local computer equipment 306 via an external network such as through the Internet.

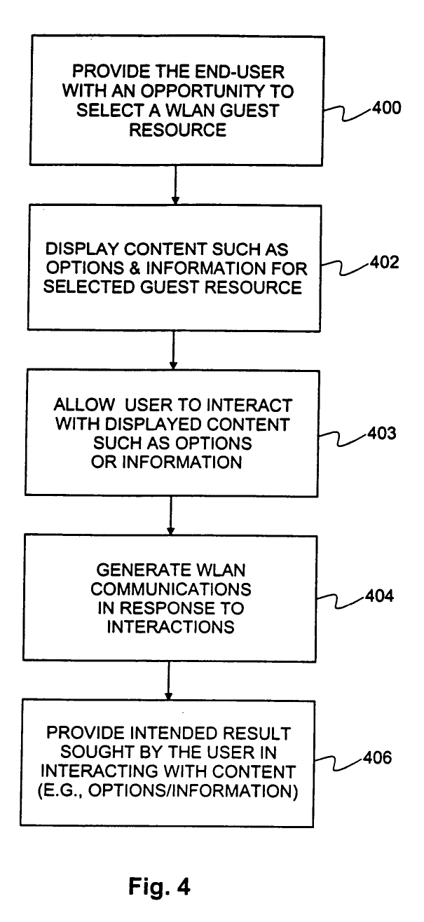

Guest services or information associated with a current accommodations provider or associated with a locality of the current accommodation provider may be provided to guests through a portable WLAN interface. For example, with reference now to FIG. 4, at step 400, an opportunity to select a WLAN guest resource may be provided to a user (e.g., a guest at hotel or resort). The opportunity may be provided through selectable content options on a display of a portable device having WLAN communications capability with a WLAN of a current accommodations provider. At step 402, content such as options or information that provide functionality that is related to or associated with the selected guest services, or that support the provision of related guest services or information to the current user may be displayed. For example, concierge related options or information may be displayed when a user select a concierge resource on a WLAN portable communications device. Further examples are provided herein. At step 403, a user (e.g., a guest with a WLAN portable communications device) may be permitted to interact with the displayed content (e.g., interact with the information or options configured for the selected guest resource). A WLAN guest resource may be implemented using software running in various points in a WLAN (e.g., on a WLAN server and WLAN communications devices). At step 404, WLAN communications carrying control, data, audiovisuals, information etc. for supporting software operation may be generated in response to user interaction with the display content for the selected guest services. At step 406, a result intended by the user of the WLAN (e.g., the user interacting with the display on a WLAN portable communications device) may be provided to the user. For example, a physical or electronic service may be provided to the user in response to selections made by the user.

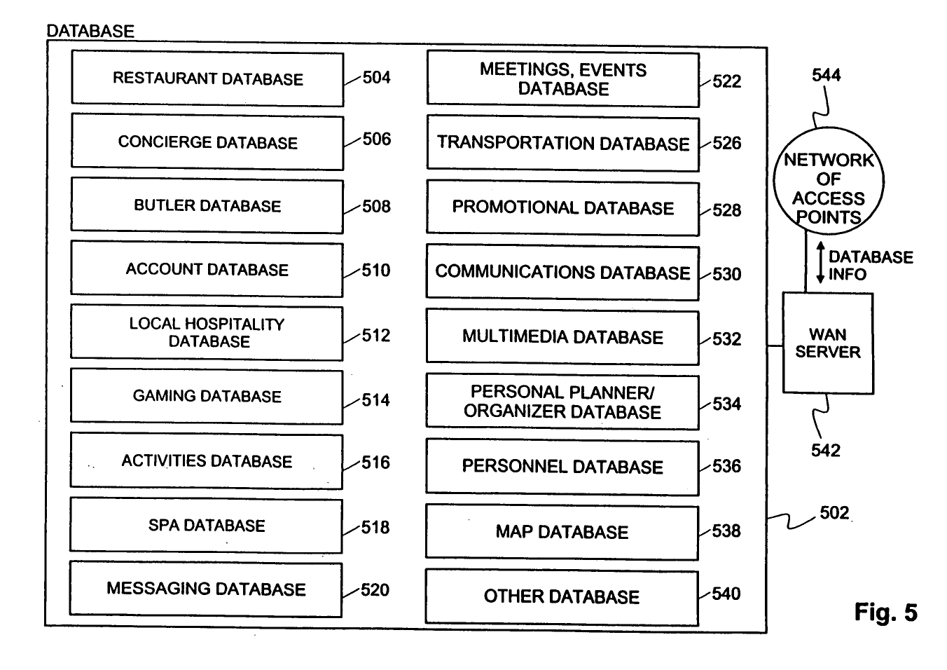

A common database may be implemented for a WLAN to provide guest services. For example, with reference now to FIG. 5, a resources database 502 may be implemented internal and/or external to WLAN server 542 (e.g., WLAN server 102 of FIG. 1) and may include the content options shown that may be accessed if selected by a user. Database 502 may be stored for example in storage 108 of WLAN server 102 of FIG. 1. WLAN server 542 may be support communications with network 544 of access points (e.g., networks illustratively shown in connection with FIGS. 1-3). WLAN communications between WLAN server 542 and network 544 may include WLAN signals carrying database content from database 502 or from WLAN portable communications devices operating within the coverage area of network 544. WLAN communications may support delivery of database files for database driven guest resources software which may have been implemented for example using XML. Database content may include content that is from or is intended for database 502 such as restaurant database 504, concierge database 506, butler database 508, account database 510, local hospitality database 512, gaming database 514, activities database 516, spa database 518, messaging database 520, meetings database 522, transportation database 526, promotional database 528, communications database 530, multimedia database 532, personal planner/organizer database 534, personnel database 536, map database 538, or other database 540. If desired, some database content may be stored in access points of network 544 or in WLAN portable communications devices to for example allow the content to be more readily accessible to WLAN operation. Content within database 502 and/or specific databases therein may include characteristics for options to be provided to support a particular WLAN guest resource that is associated with a corresponding database in database 502, information including displayable information on a particular WLAN guest resource that is associated with a corresponding database in database 502, multimedia files for a particular WLAN guest resource that is associated with a corresponding database in database 502, scheduling data (e.g., for making or viewing schedules) for a particular WLAN guest resource that is associated with a corresponding database in database 502, waitlist or reservation information for a particular WLAN guest resource that is associated with a corresponding database in database 502, promotional data or content for a WLAN promotional resource associated with WLAN guest resources and having an associated corresponding database in database 502.

More specifically, restaurant database 504 may include information on restaurants (e.g., restaurants in the campus of the guest accommodations provider, restaurants outside of the campus of the guest accommodations provider, etc.). Information may include name, address, contact information, related graphics, images or multimedia, ratings information, times of operation, menu, pricing, dress code, transportation or parking information, etc. Restaurant database 504 may also include schedule information for reservations. Concierge database 506 may include content to support interactive concierge resources provided to users via interactions with a portable WLAN communications device (e.g., to obtain information on a local festival). Concierge database 506 for example may include data on local tours or shows, luggage information, mail information, language translation information, reservations information, taxi or airport transfer information, and data on other typical activities that are handled by a concierge. Other interactive user resources, wherein a user may interact with selected data or with staff of an accommodations provider or others, may also be available, as explained below.

The term data is sometimes used herein to include one or more of the following: information, database entries, data for supporting software applications, multimedia files, other types of files, graphics, images, software, selectable resource options, and software modules.

Butler database 508 may include content to support interactive butler resources provided to users via interactions with a portable WLAN communications device (e.g., to place a drink order). Butler database 508 may for example include data on laundry services, dry cleaning services, room cleaning services, or other activities typically handled by butler services of a guest accommodations provider. Account database 510 may include content to support interactive guest account resources provided to users via interactions with a portable WLAN communications device (e.g., to allow a guest to view account billing activity). Account database 510 may for example include data on guest credit card(s) (e.g., credit cards that are on file), transaction activity, details of transaction activity, options for paying for charges, check out information, discount, promotions, or other data typically provided by account services. Local hospitality database 512 may include content to support interactive local hospitality resources provided to users via interactions with a portable WLAN communications device (e.g., to allow a guest to view local guide information). Local hospitality database 512 may include data on local attractions, tourist activities, local restaurants, local shows, directions to attractions, reservation options, electronic links to local service providers, local weather, or other data for supporting local hospitality resources provided to WLAN users.

Gaming database 514 may include content to support interactive gaming resources (e.g., blackjack, bingo, video games, horse racing, etc.) provided to users via interactions with a portable WLAN communications device (e.g., to allow a guest to play a game). Gaming database 514 may include data on games, game manuals, game odds, available prizes, gaming options, multimedia for supporting gaming, guest gaming finances, incentive-based complimentary programs, gaming history for guests, or other data for supporting gaming resources provided to WLAN users. Activities database 516 may include content to support activities resources provided to users via interactions with a portable WLAN communications device (e.g., to allow a guest to schedule an activity). The interactive activities may for example be activities that are offered by a current accommodations provider. Activities database 516 may include data on activities provided by a current accommodations provider on scheduling activities, activities providers, activity preferences, or other data for supporting activities resources provided to WLAN users.

Spa database 518 may include content to support interactive health spa resources provided to users via interactions with a portable WLAN communications device (e.g., to allow a guest to schedule a spa appointment). The health spa may for example be a health spa of a current accommodations provider. Spa database 518 may include data on spa treatment, spa amenities, hours of operation, reservation options, scheduling, spa personnel information or other data for supporting spa resources to WLAN users. Messaging database 520 may include content to support messaging resources for users of the portable WLAN communications device with the accommodations provider. Messaging resources (e.g., to allow the user to for example send or receive messages) may include voice, text, graphics, video, two-way, or one-way communications. Messaging database 520 may include data on canned messages, available message recipients, options for messaging, or other data typically supported for messaging resources.

Meetings/events database 522 may include content to support interactive meeting/events resources provided to users via interactions with a portable WLAN communications device. Meeting/events database 522 may for example be for conferences or other meeting/event activity provided by a guest accommodations provider or provided by a near by facility. Meetings/events database 522 may include data on meetings, events, scheduling, scheduling options, location information, or other data that supports interactive meeting/events resources being provided to WLAN users. Using meetings/events database 522, a guest may for example be scheduled to attend a meeting or seminar upon the guest's request.

Meetings/events database 522 and supporting software may be configured to use a portable WLAN communications device to assist in the logistical communications of personnel charged with co-coordinating large scale conference type events at a location and in turn providing portable WLAN communications devices to conference event attendees in order to give them access to conference proceedings, logistics schedules, changes, announcements, or other related information of automated resources.

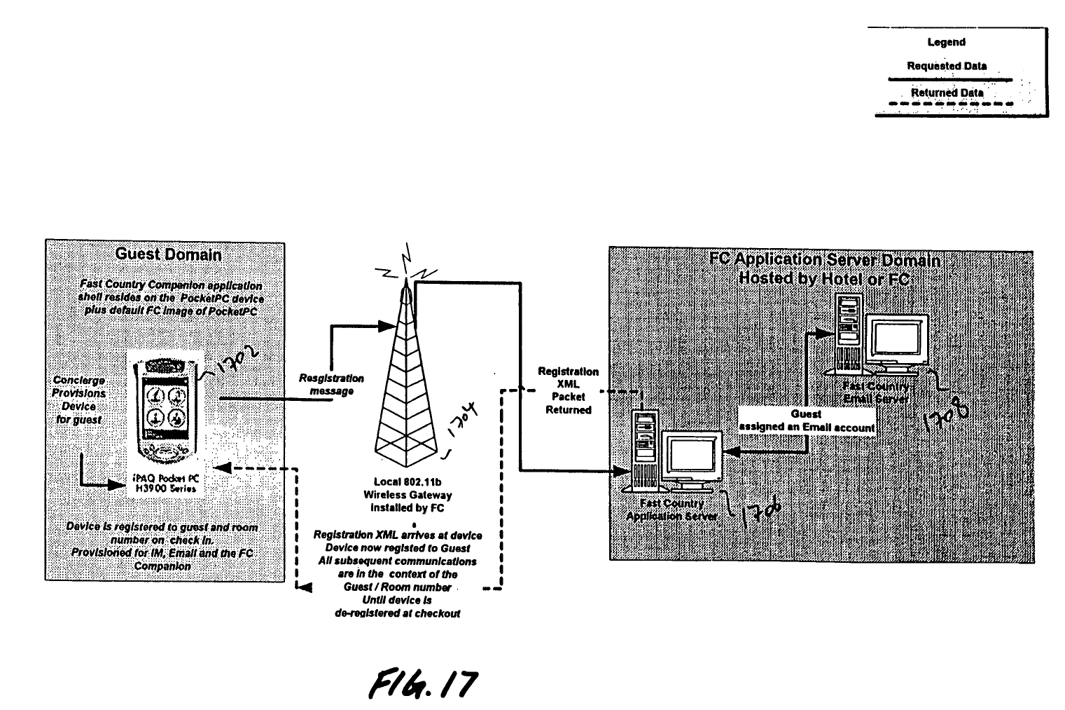

Portable WLAN communications devices, supporting WLAN, and supporting applications may be used in a specific instance to provide services, information, auditing, communication and overall convenience to conference planners and managers of accommodations providers associated with conference planning and in this case the system may be equipped with special software (e.g., relational database software) and event specific content that enables the smooth execution of conference events while providing a centralized access to all event schedules. In some specific instance, if desired, the portable WLAN communications device may be used to provide services, information, logistical data and other content to conference attendees as a part of the conference package. In such situations, the portable communications device may be provisioned (e.g., see discussion below in connection with FIG. 17) prior to the attendee arriving but after the attendee has registered with pertinent attendee personal information and may be used by the attendee throughout the lifetime of the conference to interact with the conference planners and presenters and may also be used by the attendee to access professional intranets, portals and other content, additionally professional e-mail and other communications while they are out of the office. Such conference related features may, if desired, be provided to attendees who are not guests of an accommodations provider that is hosting the conference or are not guests of an accommodations provider that is associated with the conference (e.g., services are only provided to attendee as an enhancement to the conference experience). Examples of systems providing certain conference related features are illustratively described in U.S. Patent Application Publication No. US 2002/0016729 A1, which is hereby incorporated herein in its entirety.

Transportation database 526 may include content to support interactive transportation resources provided to users via interactions with a portable WLAN communications device (e.g., to allow a guest to call a taxi or reserve a car). The interactive transportation services may for example provide travel information and options to users. Transportation database 526 may include data on local transportation, transportation fee, transportation schedules, reservation options, ticket purchasing options, transportation maps, or other data that may be needed to support interactive transportation resources to users.

Promotional database 528 may include content to support interactive and passive promotional resources (e.g., advertisement displays) provided to users via portable WLAN communications devices. Promotional database 528 may support providing advertisement, promotions, discounts, coupons, rebates, sweepstakes to WLAN users with a visual or audio interface of WLAN portable communications devices. Promotions database 528 may for example include data on promotions, advertisements, promotion related options, presentation of promotions, or other data that may be used to support promotions within a portable WLAN environment being provided to users.

Communications database 530 may include content to support interactive communications resources (e.g., voice over IP, wireless telephone resources, paging, Internet Web sites, telnet, FTP, etc.) that is provided to users via interactions with a portable WLAN communications device. Communications database 530 may include data on communications addresses, assigned communications capabilities, amount of communications usage, free for communications usage, options for configuring and establishing communications, or other data used to support communications resources for WLAN users.

Multimedia database 532 may include content to support multimedia resources for users of portable WLAN communications device. Multimedia database 532 may support the presentation of multimedia to WLAN portable communications device users via techniques such as multicast streaming techniques. Multimedia database 532 may for example include data on audio video presentations, identifying of what is associated with presentations, characteristics of presentations (e.g., name, duration, etc.), options for configuring or controlling presentations, or other data for supporting multimedia resources for portable WLAN communications device users.

Personal planner/organizer database 534 may include content to support interactive personal planner/organizer resources including for example a professional desktop provided to users via interactions with a portable WLAN communications device. Personal planner/organizer resources (e.g., including professional desktop resources) may provide users with a temporary resource for accessing their personal or professional calendars, organizers, or business utilities which may have been interfaced with the guest's desktop computer, office server, or other personal or professional resources. Personal planner/organizer database 534 may include data on calendars (including scheduled appointments), task, options for viewing and configuring planner/organizer settings, word processing options, contact lists, or other data for supporting personal planner/organizer resources on portable WLAN communications device for guests of an accommodations provider that implemented the WLAN.

Personnel database 536 may include content to support interactive personnel resources to users via interactions with a portable WLAN communications device. Personal resources may for example, permit users to view information on personnel of accommodations provider, to communicate with personnel through the portable WLAN communications device, to give gratuities to personnel, to submit complaints regarding personnel, to request particular personnel to provide services, etc. Personnel database 536 may include data on personnel images, personnel profiles, personnel position information, personnel communications address information, personnel schedule information, or other data for supporting interactive personnel resources on portable WLAN communications devices.

Map database 538 may include content to support interactive map or user locator resources via interactions with a portable WLAN communications device. Map or user locator resources may for example provide maps or schematics of the campus or locality of a guest accommodations provider of a floor map and may identify where a user is currently located for the user's information and for use by other resources. Map database 538 may include for example data on location maps, site schematics, names of different campus or geographic locations, campus indicator, or other data for supporting map or user locating resources to WLAN users. Database 502 may include other database 540 for storing additional interactive WLAN resources for guest resources provided to guests of a guest accommodations provider.

Although the various databases are generally intended to contain related but different information, it is also contemplated that certain activities or features can be listed in more than one database. Alternatively, one database can have a link to a particular feature or activity of another database. For example, information in the restaurant database can include links or advertisements of attractions that are located in the vicinity of the selected restaurant. The health spa database can include links to other exercise activities, such as golf or tennis facilities. Both of these databases can have links to the map database to show how to find the location or activity of interest. In the present system these databases become an effective tool for assisting the user to locate activities of interest in an efficient and highly convenient way.

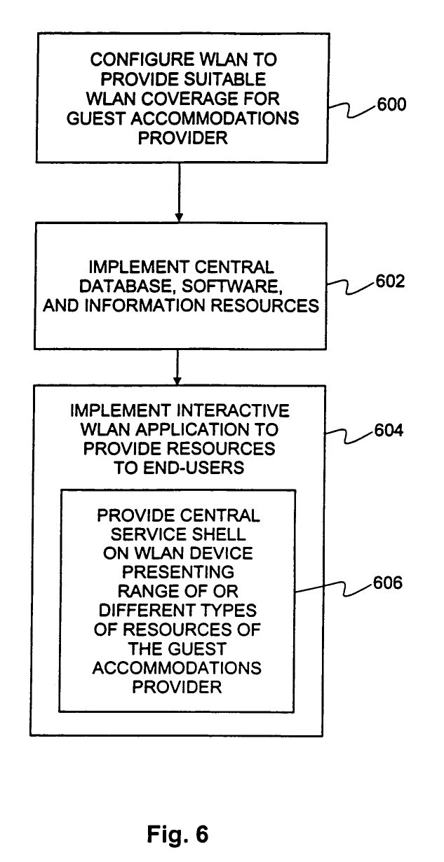

One advantage of a WLAN is that a central resource of database, software, and information, may be implemented for an accommodations provider to provide a variety of recourses to guests via the WLAN. For example, with reference now to FIG. 6, at step 600, a WLAN may be configured to provide suitable WLAN coverage for an accommodations provider. At step 602, one or more databases, software applications, or information files may be implemented to be centrally stored for sharing database, software application, and information file content between multiple WLAN users. At step 604, an interactive WLAN application may be implemented to provide resources to users of the WLAN (e.g., via interactions with displays on portable WLAN communications devices). Step 604 may include step 606. At step 606, a central software application shell for presenting a central interface may be provided for presenting a range of resources (or different types of resources) of the guest accommodations providers using the databases, software applications, and information files. Thus providing a multi-function platform through which WLAN users can access a host of guest accommodations services.

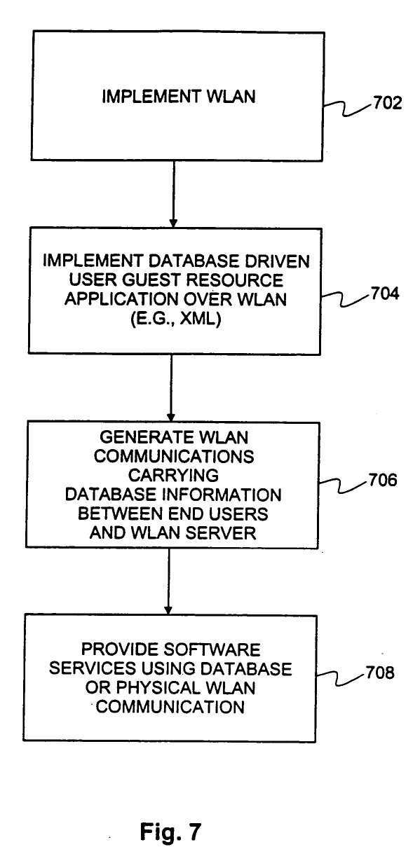

A database driven software language or technique such as XML may be used to implement interactive guest resources on a WLAN through which the guest resources may be made available on portable WLAN communications devices. For example, with reference now to FIG. 7, at step 702, a WLAN may be implemented within an area such as the campus of a guest accommodations provider. At step 704, database driven guest resource applications (e.g., a concierge resource, a butler recourse, an organizer resource, etc.) may be implemented over the WLAN. The applications may be implemented using XML or other database software programming techniques. At step 706, WLAN communications may be generated based on (e.g., in response to) user interactions with database driven user guest resources. The WLAN communications may carry database content (e.g., see FIG. 5 and related text) between WLAN portable communications device users and a WLAN server (e.g., a database in the WLAN server). At step 708, software services (e.g., display of desired information, automated scheduling of massage appointment, etc) or physical services (e.g., delivery of drinks, maid services, etc.) may be provided to guest via the use of database WLAN communications. Thus, guest services with dynamic content may be provided quickly and efficiently using database type programming techniques.

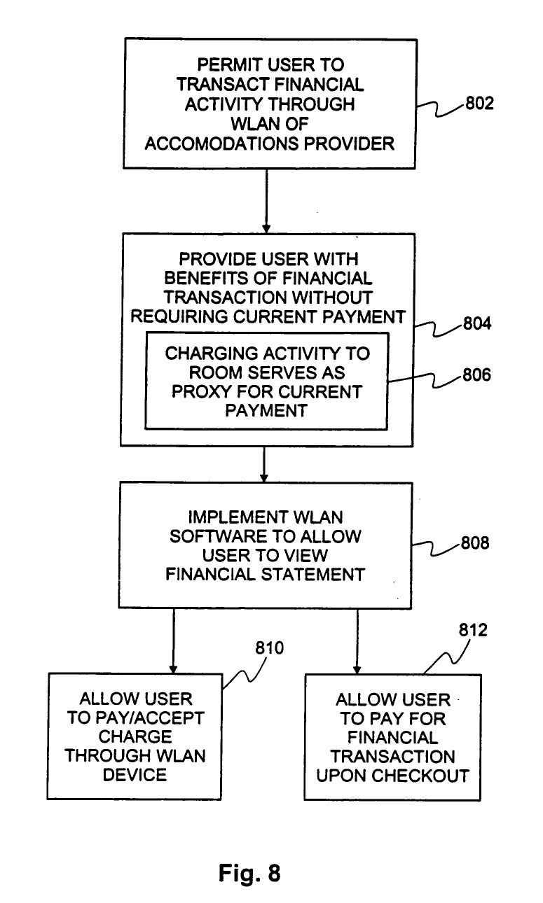

One advantage of a centralized guest services platform on a portable device is that it may eliminate the need for guests to carry cash or credit cards when enjoying different activities. For example, with reference now to FIG. 8, at step 802, a software application may be implemented in providing interactive guest resources over a WLAN of an accommodations provider that permits guests of the accommodations provider to transact financial activity through the WLAN (e.g., using a portable handheld device). A user may be permitted to transact financial activity in association with interactive guest resources. At step 804, a user may be provided with benefits of financial activity (e.g., poolside drink delivery, recreational activities, etc.) without requiring a current payment by the beneficiary of the service. For example, at step 806 (which may be part of step 804), financial activity may be charged to a guest's room which serves as a proxy for a payment. Financial activity may be charged to a guest's room when transactions are performed using a portable WLAN communication device (or guest resources application for a portable WLAN communications device) that is assigned to the guest. For convenience, features discussed herein are sometimes primarily discussed in the context of a portable WLAN communications device that is assigned to a user. However, in some circumstances, a guest may already own a portable WLAN communications device, in such cases, desired software is assigned to a guest and deployed on the guest's device to provide desired services.

At step 808, WLAN software may be implemented over the WLAN (e.g., running on portable WLAN communications devices, access points, WLAN server, or combinations thereof) to allow users to view their financial statement, which may include entries generated through financial activity charged through the portable WLAN communications device. An account database may be implemented, see for example FIG. 4 and related text, to support such services. At step 810, a user of a portable WLAN communications device may be permitted to pay for or accept charges that where made through the WLAN device. For example, the user may use payment information that is already on record to select one or more charges to pay or may provide debit or credit card information to proceed with payment for one or more charges. If desired, a card reader may be coupled with a portable wireless communications device to assist in such activity. At step 812, a user may be permitted to pay for financial charges which have accumulated (for example, through a portable WLAN communications device) upon checkout from the accommodations provider. Thus, a new form of credit line may be implemented using the WLAN guest resources of an accommodations provider.

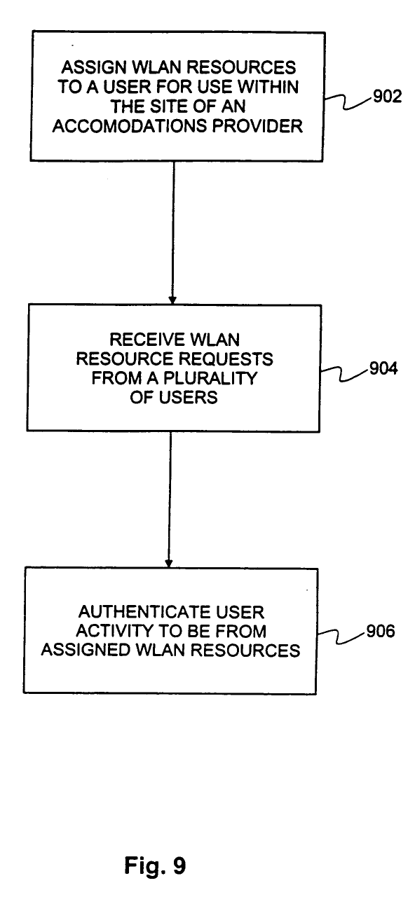

Security measures may be implemented to prevent fraudulent transactions. For example, with reference now to FIG. 9, at step 902, WLAN resources for providing guest resources through a portable WLAN communications device may be assigned to a user for use within a WLAN of a current accommodations provider. At step 904, a WLAN server or access points providing the WLAN of the accommodations provider may receive resource requests (e.g., request to partake in financial activity, to receive guest services, etc.) from a plurality of users. At step 906, user requests for resources may be authenticated to be from an appropriate or authorized one of the assigned WLAN resources. Authentication may be performed periodically, responsive to user requests, before receiving use requests, or using other techniques. Authentication may be provided using various techniques involving a unique identifier such as entry of a personal identification code, pseudorandom code generation using a seed associated with a particular device, bio-authenticating techniques, unseen device number associated with a device assigned to a user, obtaining an image of the user through the portable WLAN device, voice recognition, etc. Other authentication techniques may also be implemented. Thus, an accommodations provider may further encourage guests to use such devices due to additional security precautions.

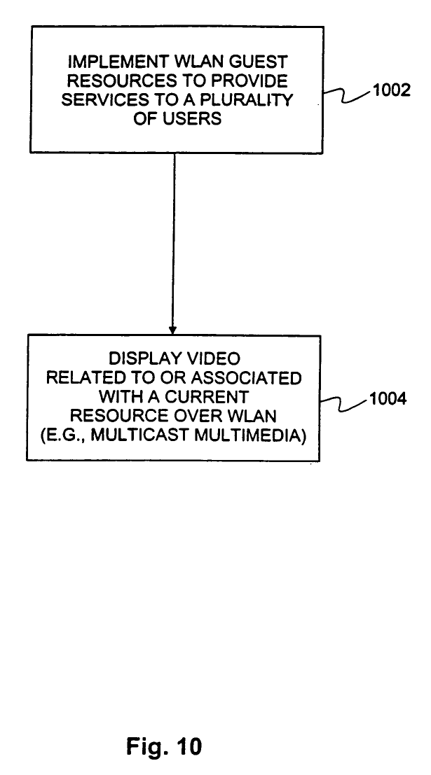

The guest resources platform illustratively described herein may be a tool for accommodations providers through which providers may enhance a guest's experience. If desired, streaming media may be provided through the guest resources platform to further enhance the guest experience. For example, with reference now to FIG. 10, at step 1002, WLAN guest resources may be implemented to provide services to a plurality of users. At step 1004, video may be displayed with the presentation of a current guest resource to a user to further enhance the current resource. For example, audiovisuals may be presented on a portable communications devices using multicast of multimedia over a WLAN (e.g., using techniques similar to or including User Datagram Protocol (UDP)).

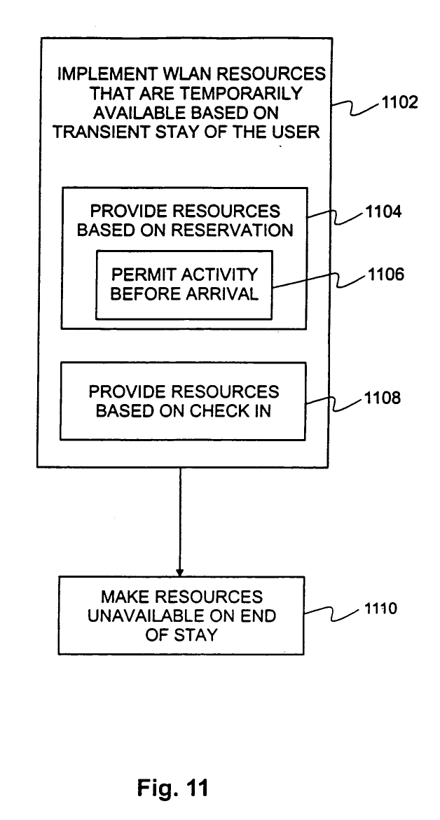

WLAN guest resources may be provided on a temporary basis. For example, with reference now to FIG. 11, at step 1102, WLAN resources may be implemented that are temporarily available based on the transient stay of a user. A software shell may be implemented to provide interactive guest resources on a WLAN of an accommodations provider, where the resources are used to interface with guests through portable WLAN communications devices assigned to the users. As step 1104, which may be part of step 1102, guest resources may be provided to a user based on the user making a reservation (e.g., paying for a particular stay) with the accommodations provider. This may include step 1106 which may provide a user with the opportunity to interact with a WLAN of an accommodations provider through an Internet portal before the guest arrives on the premises. If desired, resources may be provided to a guest upon checking into the accommodations provider. Upon check in, a portable WLAN communications device may be assigned to the guest (e.g., assigned when the guest rents the device). At step 1110, the resources may be made unavailable upon the end of the guest's stay with the accommodations provider (e.g., upon checking out of the hotel). Step 1110 may include an automated step in which information, configurations, settings, files, or other guest related content may be automatically cleared from a portable WLAN communications device upon checkout, when the guest temporary stays has ended, upon return of a rented portable WLAN communications devices. If desired, in circumstances where the portable communications device is not a rental, features may be implemented to remove WLAN software from a user's device. If desired, a core application may be kept in the device. However, the authority of the guest to use guest resources over the WLAN of the accommodations provider may be terminated.

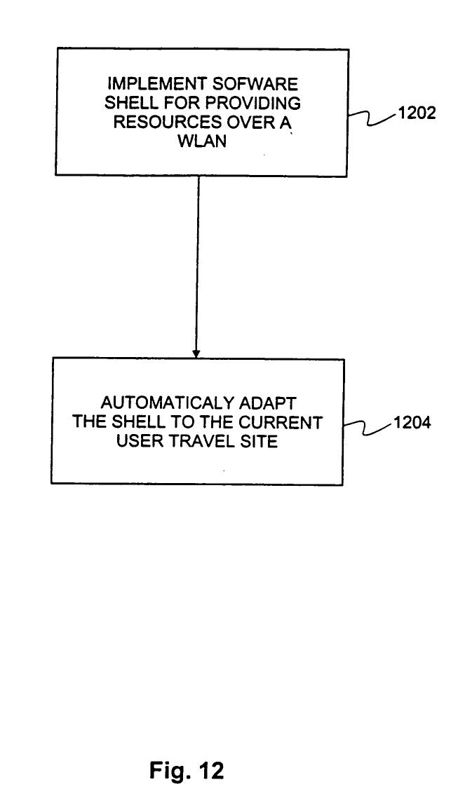

A plurality of remotely located accommodations providers may wish to use such services for their facility. A software shell may be implemented that automatically adapts its options, displays, presentations, and configuration based on which one of the plurality of plurality of accommodations providers a WLAN communications device is currently located or will be located for a transient stay. For example, with reference now to FIG. 12, at step 1202, a software shell for providing a platform providing guest resources over WLANs may be implemented on a portable WLAN communications device. At step 1204, the shell or the content of the shell which provides guest resources to a user may automatically be adapted to the current site in which a user is located (e.g., adapts to provide WLAN guest resources available for the current accommodations providers). A software shell providing dedicated software running to provide different services has sometimes been referred to as a “walled garden”. Thus, a central shell for presenting guest services to a guest may in some ways be considered a WLAN walled garden for guests of the accommodations services industry.

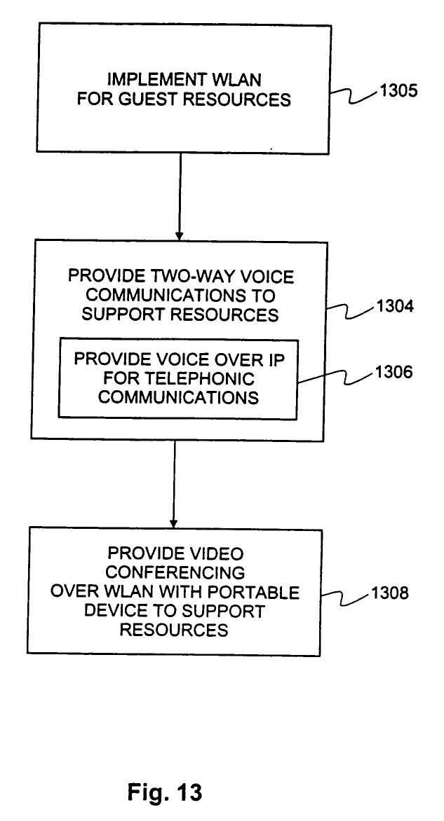

A guest's experience may be further enhanced by telephonic communications over a WLAN of an accommodations provider. For example, with reference now to FIG. 13, at step 1302, guest resources may be implemented over a WLAN of an accommodations provider to permit guests to access the guest resources through their portable WLAN communications devices. At step 1304, two-way voice communications may be provided using the portable WLAN communications devices to enhance or support guest resources. At step 1306, Voice Over IP (VOIP) may be implemented to provide telephone communications. Step 1306 may be implemented in providing steps 1304. If desired, at step 1308, video conferencing may be provided over WLAN of accommodations provider.

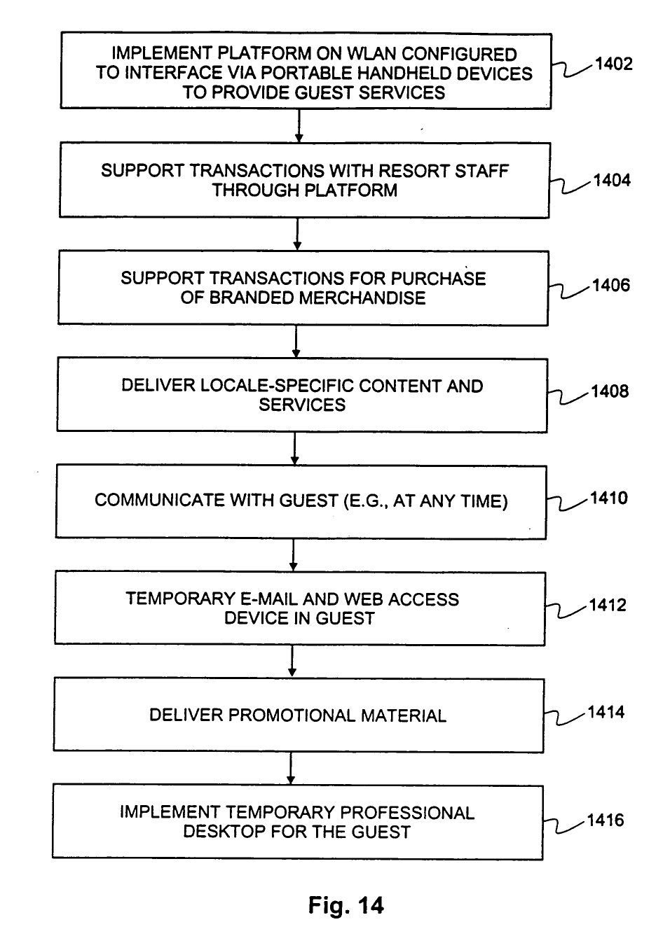

As mentioned above, a variety of services may be provided on a multi-function platform to enhance a guest's stay and to organize the wealth of services and information that may be available to the guest in electronic form in a more manageable way than existing paper or distributed sources for such information and services. For example, with reference now to FIG. 14, at step 1402, a platform may be implemented on a WLAN that is configured to interface with guests using portable handheld WLAN communications devices to provide guest services. At step 1404, the platform may support transactions with resort staff (e.g., through the WLAN communications device). At step 1406, the platform may support a guest's purchase (e.g., through the WLAN communications device) of merchandise that is branded by the accommodations provider. At step 1408, locale specific content and services may be delivered to a guest through their WLAN communications device. At step 1410, the WLAN may provide communications with guests through their WLAN communications device (e.g., provide communications with guests at any time). At step 1412, temporary e-mail and web access may be provided to guests for use for example through their WLAN communications device. The e-mail account and web server may be tied to the user's transient stay with an accommodations provider. At step 1414, promotional material may be presented in one or more displays that are present on the WLAN communications device of a user. At step 1416, a temporary professional desktop may be implemented for a guest using their WLAN communications device to allow guests to keep up to date with business concerns without having to travel with their laptop or other office equipment. The portable wireless communications device also provides a less intrusive means for addressing work concerns. Other guest resources, such as those illustratively described herein may also be provided. Databases, software, or features for providing guest services are illustratively described at various points herein.

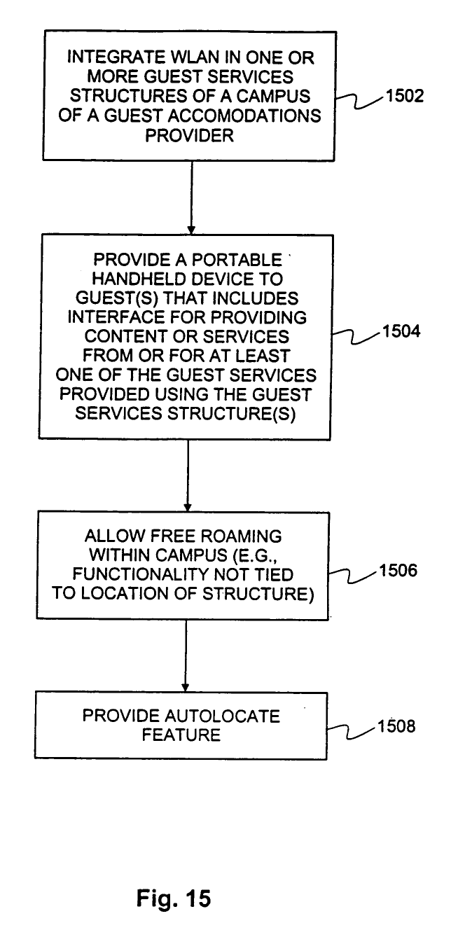

Another advantage that may be realized is that a user may roam with a portable WLAN communications device within a WLAN area of a guest accommodations provider without tying the availability of guest resources to a current service facility of the accommodations provider within the guest is located (including the area in the immediate proximity of the current service facility). For example, interactive guest resources for a particular restaurant on the campus of the accommodations provider may be made to be available when a guest is outside of the restaurant or in a different restaurant. With reference now to FIG. 15, at step 1502, a WLAN may be integrated with one or more guest services structures or facilities that are on the campus of a guest accommodations provider. At step 1504, a portable handheld communications device supporting WLAN communications may be provided to guest(s) for providing content or services from or for one or more of the guest services which may be provided to guests using one of the guest services structure(s) or facilities. At step 1506, allow free roaming within the WLAN area of the campus without tying the functionality of the device or availability of services to any location or structure (e.g., restaurants, shops, swimming pools, tennis courts, health spa) within the WLAN area. At step 1508, an automatic locating feature may be provided. Various automated techniques for locating a guest (e.g., close approximation of guest location) may be implemented. For example, locating may be provided by triangulation techniques used to locate a guest's portable communications device, the identity of a current access point that a particular guest is using in his or her communications may be indicative of the location of a user, a user may be prompted to identify their location through an interface on the portable communications device (e.g., a graphical display shows particular selectable spots within an area that a user can select to identify his or her specific or approximate locations), an approximate location of a guest may be identified based on a roaming pattern of his or her device, the location may be identified from an appointment that a guest made through their device, a beacon signal generator may be included as part of portable WLAN communications device to identify the location of the user, or other suitable techniques may also be used. If desired, the location of the user may be presented to a user in a graphic display of a map or site schematic.

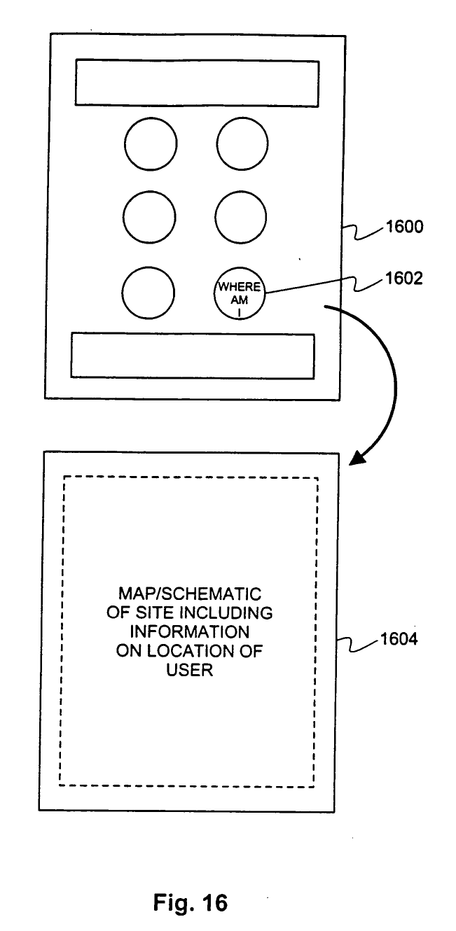

Locating features may be implemented in a number of different ways. For example, with reference now to FIG. 16, navigation display screen 1600 may include a plurality of options that may include locating option 1602. The plurality of options may be used to navigate to different guest resources that are available through a software shell for providing guest services of a WLAN of a current accommodations provider. Map/schematic display 1604 may be displayed on a portable WLAN communications device that includes a display of a map or schematic and information displayed in the map or schematic that identifies the location of the guest that interacted with locating option 1602. The displays generated for use in interacting with a guest through their portable WLAN communications device are configured to meet the size and visibility restrictions of such portable communications device. Thus, such displays may not be configured for display on devices of other portable communications devices such as desktop computers or pagers.

If desired, the unit can also include any of the features that are found on a portable telephone or a PDA. In addition, the unit can include remote control features for televisions or other electronic equipment that is available from the accommodations provider. Thus, e.g., a guest at a resort or hotel can have all of the amenities that he or she is used to in their home or office environment, or even more, in a single unit.

If desired, the portable WLAN communications device may be configured as a host for an imaging device such as a camera which guests may use to take a collection of still or moving images and then retrieve them from the device or servers (of the accommodations provider) where they were stored and either email them (using the device and the email service provisioned) from the device or take them home for personal or professional purposes.

One illustrative embodiment of techniques illustratively described herein is shown in FIG. 17. Specifically, signaling and processing activity for registration of a new guest is illustratively shown in FIG. 17. A concierge or other representative of an accommodations provider may provision portable WLAN communications device 1702 (which may for example be a Pocket PC) for a guest. Device 1702 may include an application shell that resides on the device and if desired, device 1702 may include images or other graphics for presentation to the guest in using guest services. If desired, a software application shell may be implemented and may operate in a way that loads content (e.g., content as required) from a central server (e.g., application server 1706), which may be content that is not only user or hotel content but may also include menus, screens, and graphics (e.g., as needed). Thus by provisioning, the shell will be filled with content for example, when needed, upon registration, etc. If desired, device 1702 may be registered to a guest and/or to the guest's room number on guest check in. Registration may include provisioning the device for instant messaging, e-mail, and other features for the current guest who has checked in. Device 1702 may send a registration message carrying guest information when device 1702 is provisioned to the guest. The registration message may be sent over a WLAN of the current accommodations providers, for example, via wireless gateway 1704 using the 802.11b standard. The registration message may be delivered to application server 1706. Application server 1706 may communicate with e-mail server 1708 to assign an e-mail account to the guest (e.g., a temporary e-mail address for their stay at the facility). In response, application server 1706 may send a registration packet (e.g., an XML packet) to device 1702 via the WLAN. The message that is delivered may be the registration message that was sent by device 1702, which may be returned to device 1702 as confirmation. Once registration has occurred, subsequent communications are in the context of the guest/room number of the guest until the device is de-registered at checkout.

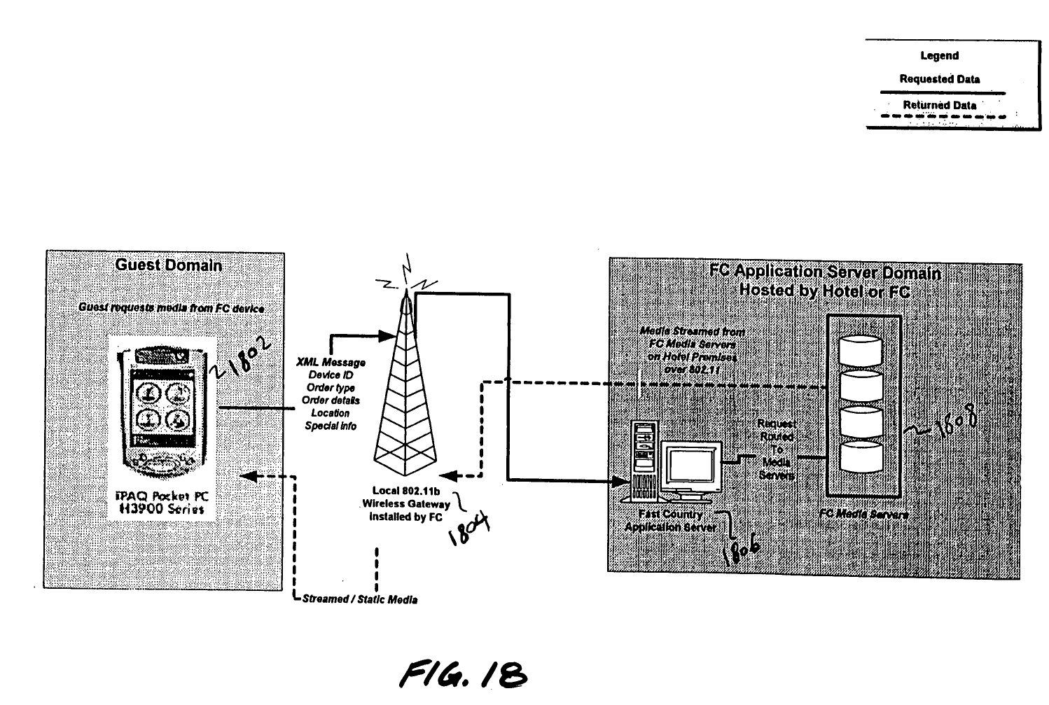

As mentioned above, media may be provided to a guest through their communications device. For example, with reference now to FIG. 18, a guest may interact with an interactive media resource that is provided on portable WLAN communications device 1802 to request media. Device 1802 may send a message over a WLAN of the accommodations provider which may include a wireless WLAN gateway. The message may be a database type message (e.g., an XML message) that may carry a device identification, order type, order details, location, or special information. The message may be delivered to application server 1806. Application server may route the request to media servers 1808. Media servers 1808 may stream the requested media from media servers 1808, which for example may be located on the premises of the accommodations provider. The media may be streamed over the WLAN using communications standard such the IEEE 802.11b standard. As mention herein, other WLAN standards may also be used if desired. In response, streamed and/or static media is delivered to device 1802 over a WLAN and the media is presented to the guest on device 1802. A display interface for interactions with a guest on device 1802 may be implemented using Macromedia Flash software. Other software may also be used if desired.

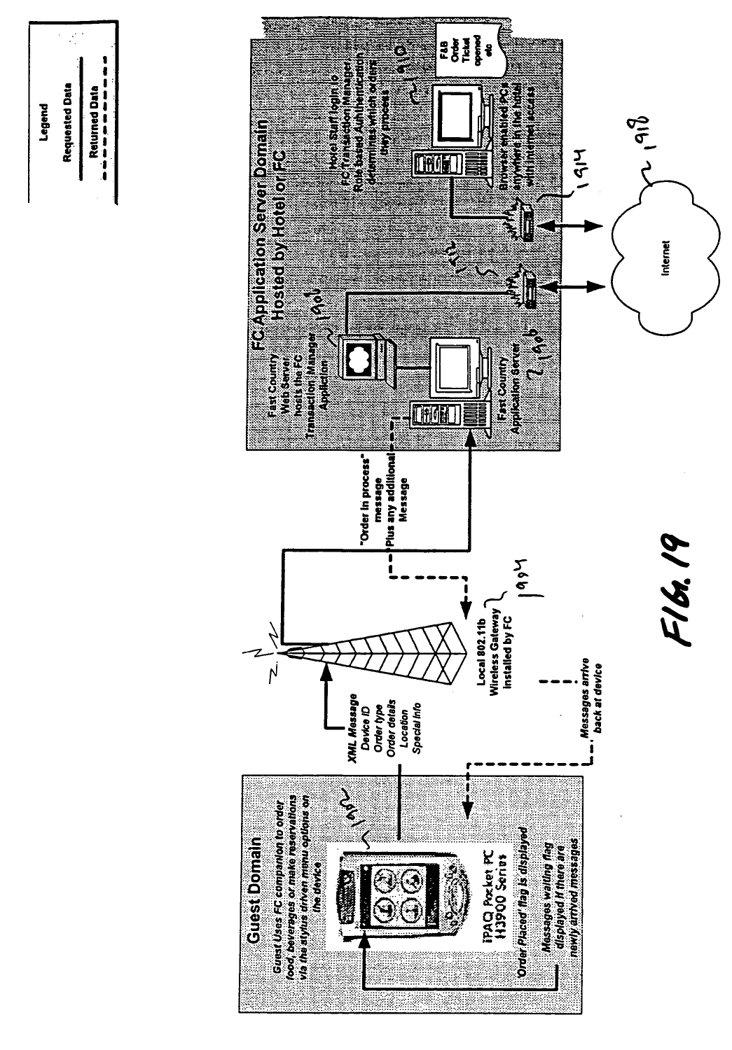

FIG. 19 shows illustrative signaling and processes for providing transactions. A guest may use device 1902 including a software shell residing therein for providing guest resources to allow a guest to for example, order food, beverages or make reservations via menu options on device 1902. In response, device 1902 may send a message (e.g., an XML message) that may include device ID, order type, order details, location, or special information. The message may be carried over a WLAN of the accommodations provider that may include wireless gateway 1904 to deliver the message to application server 1906. Application server 1906 may communicate with transaction manager application 1908 that may be hosted on a World Wide Web server. Transaction manager application 1912 may provide information on the order through Internet 1918 to Internet browser enabled computers 1910 that may be located on the premises of the accommodations provider. Staff of the current accommodations provider may login to transaction application manager 1908 and may use role based authentication to identify which orders they will process. A food and beverage ticket may be opened in response to receiving a request. Transaction manager application 1908 and browser enabled computer 1910 may have links to Internet 1918 through firewalls 1912 and 1914. Application server 1906 may send an “order in progress” message plus any additional messages to device 1902. The message may arrive at device 1902. If desired, a message flag may be displayed to indicate that the message has arrived for the guest. Note that typically, food and beverage orders may be made available to guests in areas other than restaurants or bars (e.g., by pool side, on tennis courts, in a hotel lobby, at a casino gaming table, etc.). Although the use of such a device may be convenient in some ways in a restaurant or bar. Guests who are visiting the accommodations provider for a vacation will typically desire the personal attention and service that should be provided by wait staff at restaurants. Thus, if desired, a guest may make reservations at a restaurant via the interactive guest resources and in turn, may receive personal attention for their dining experience.

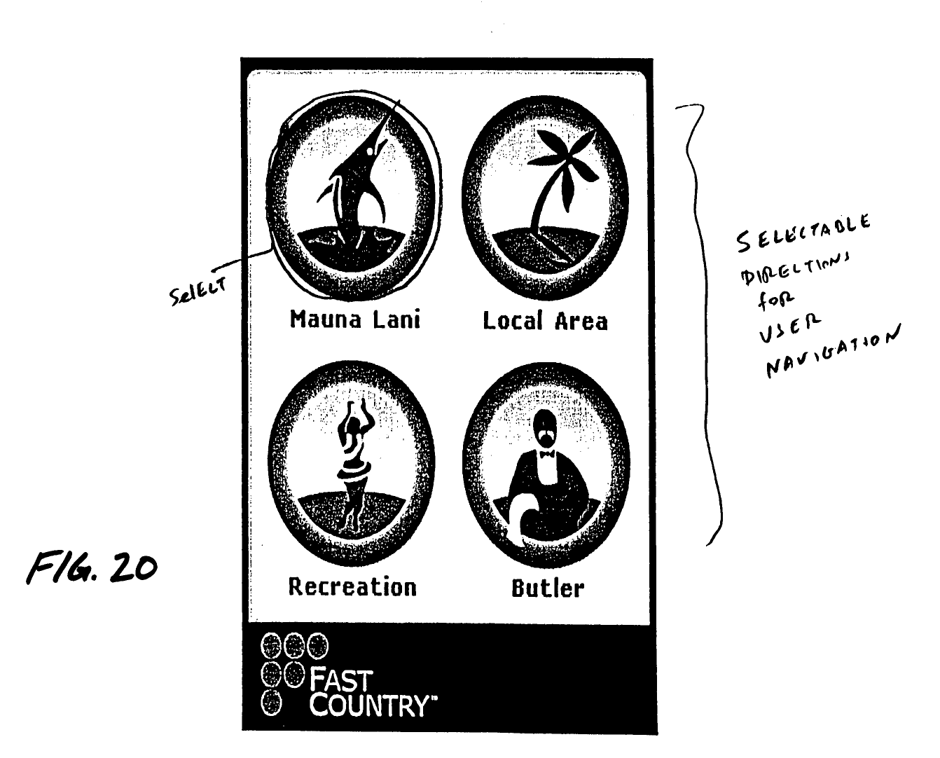

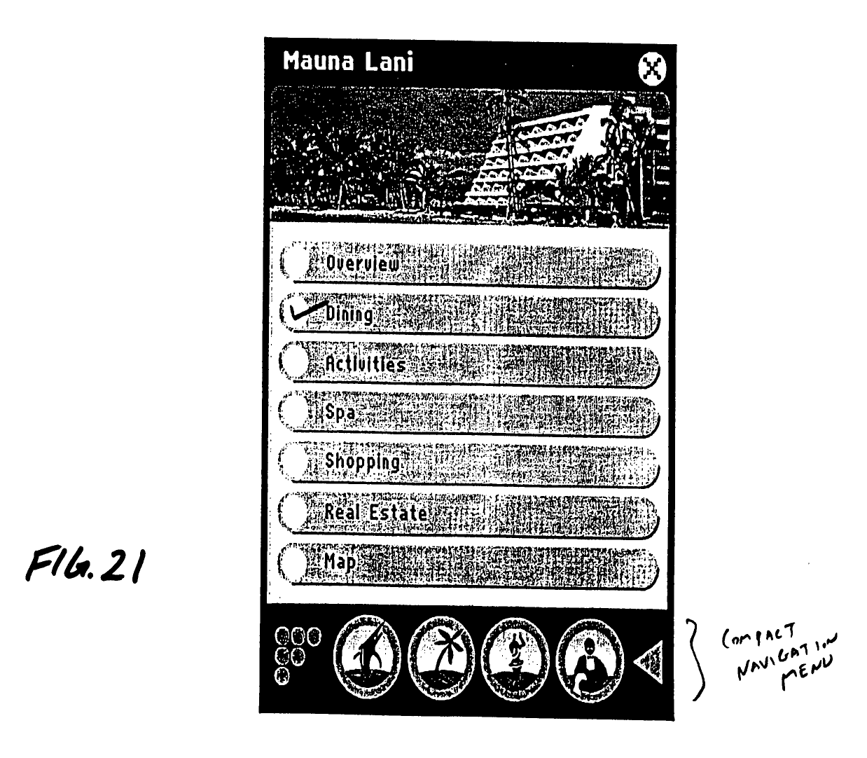

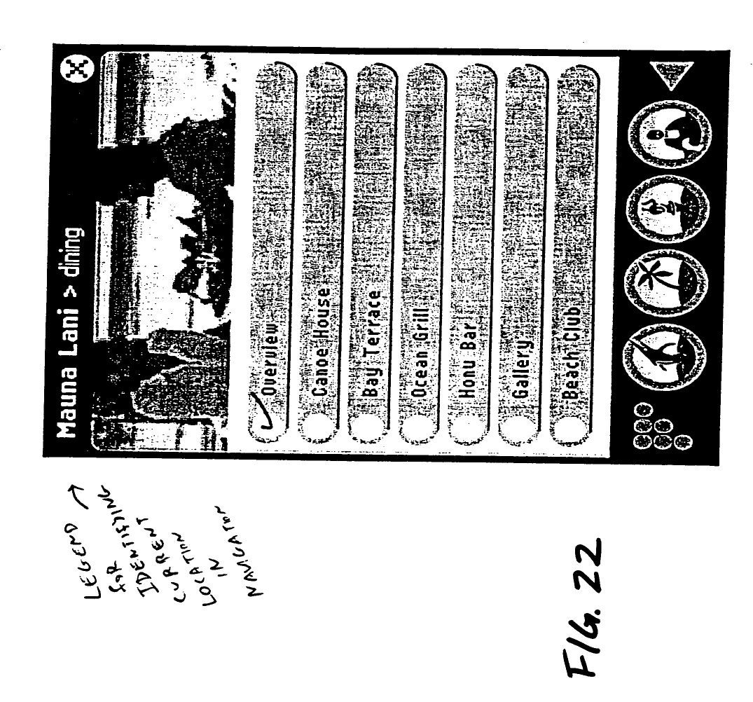

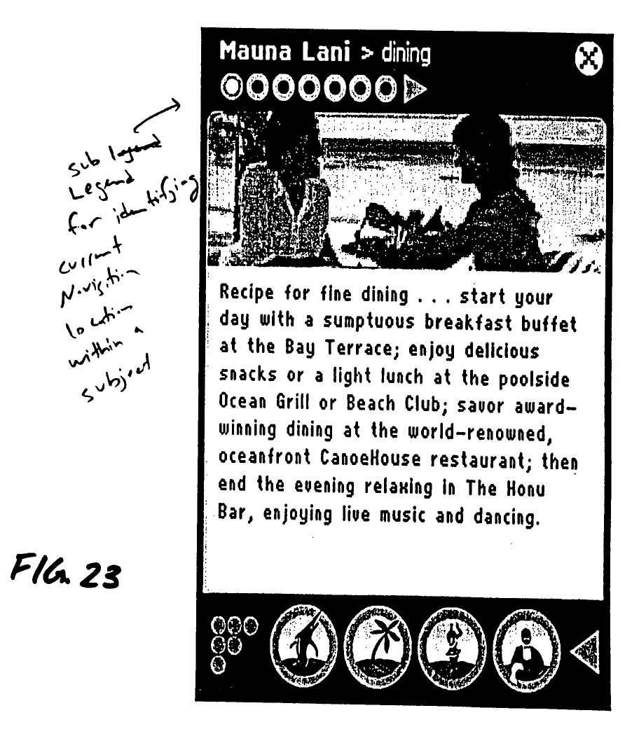

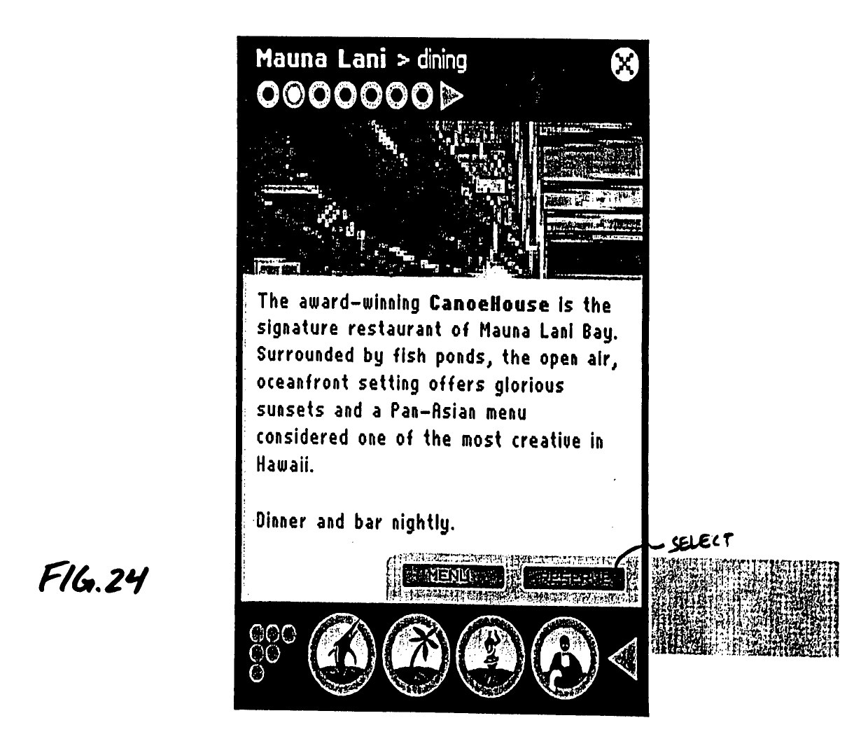

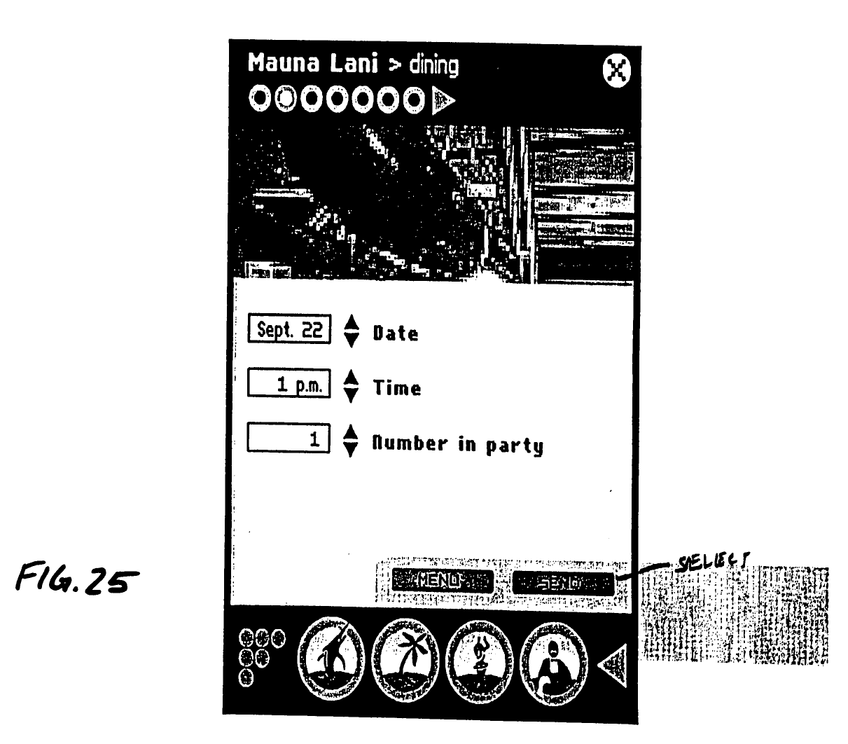

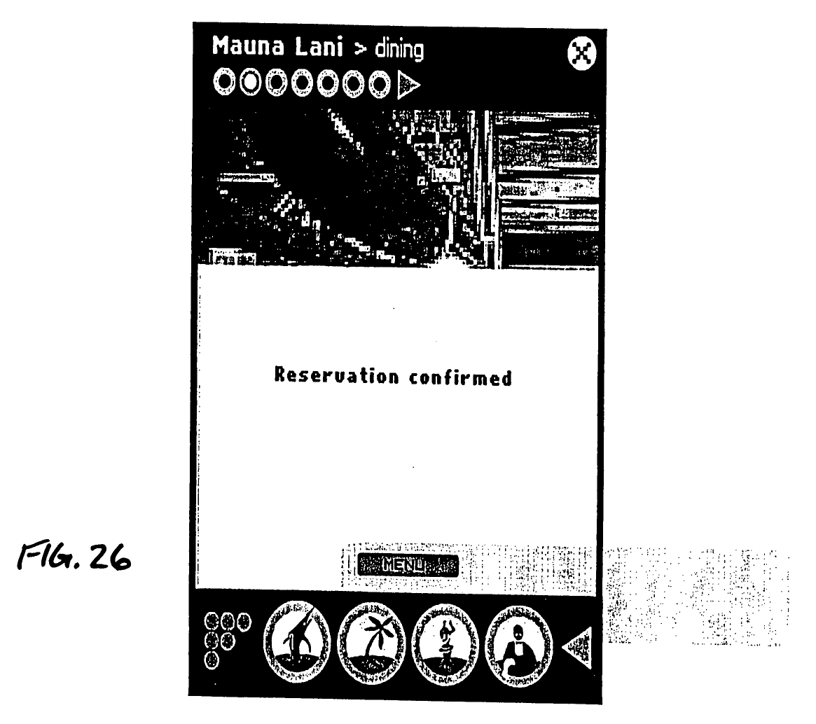

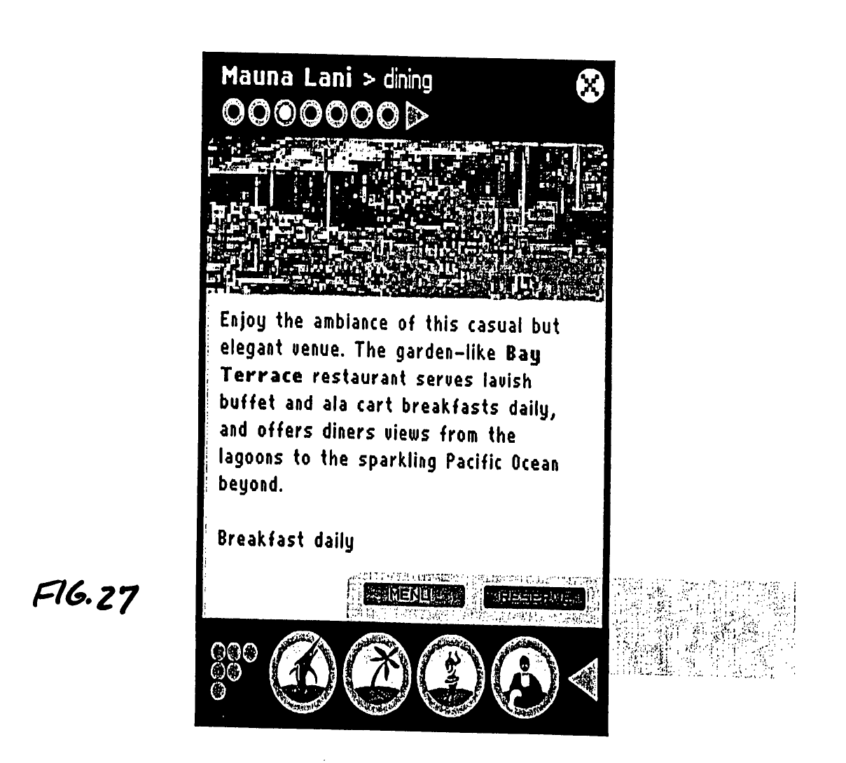

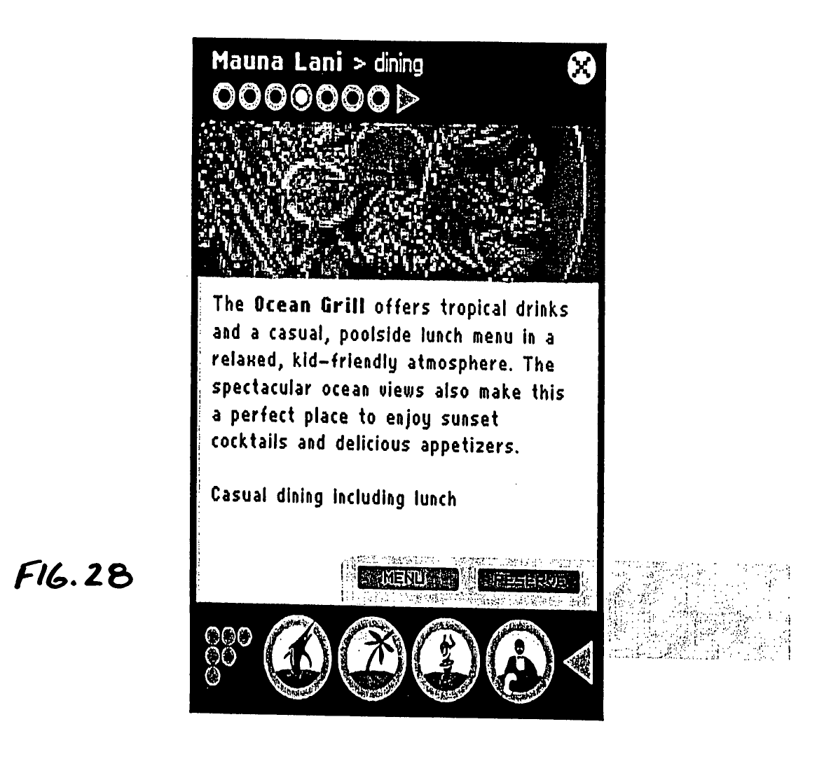

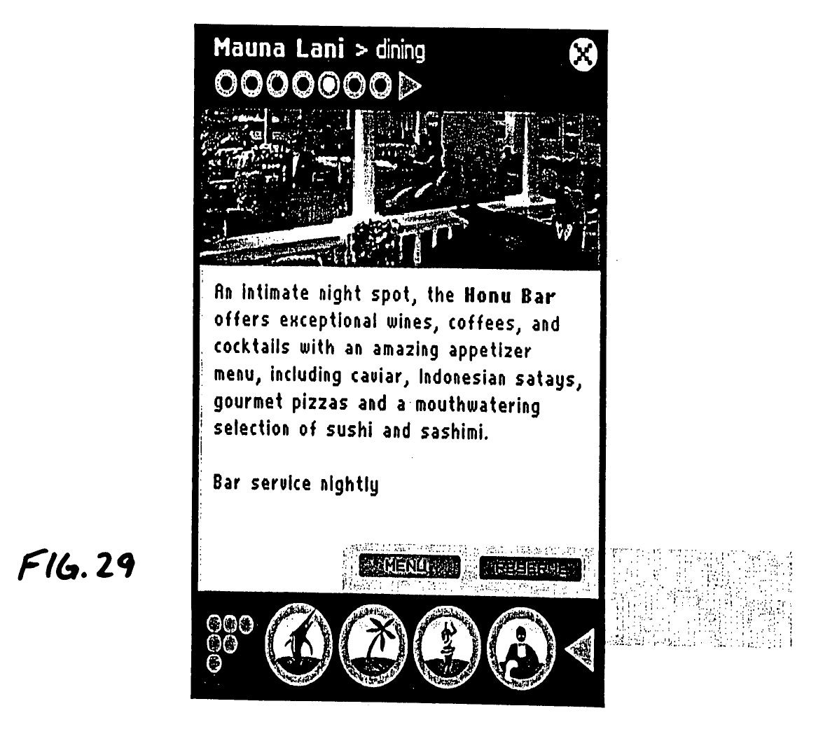

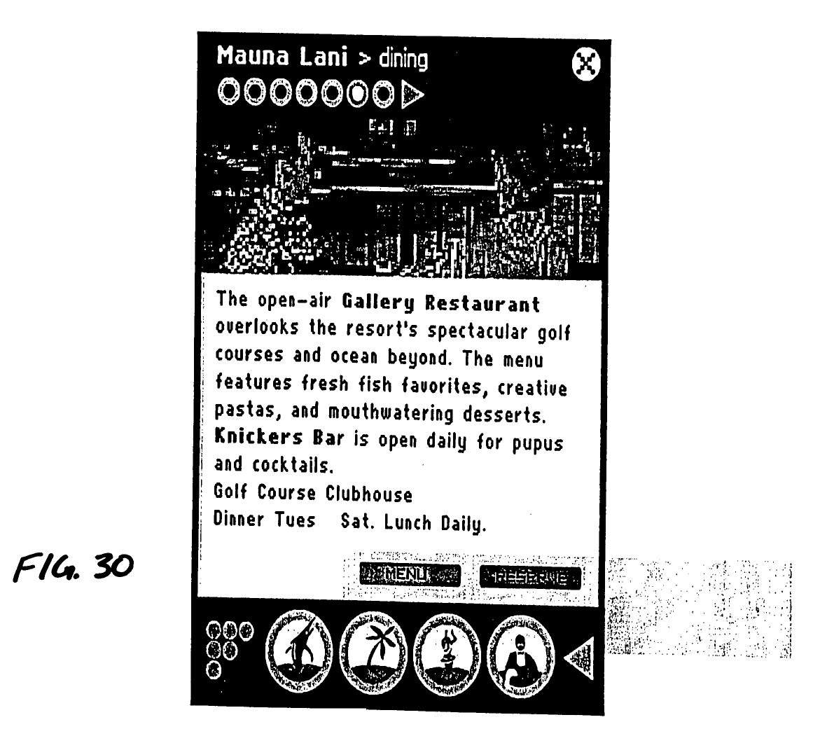

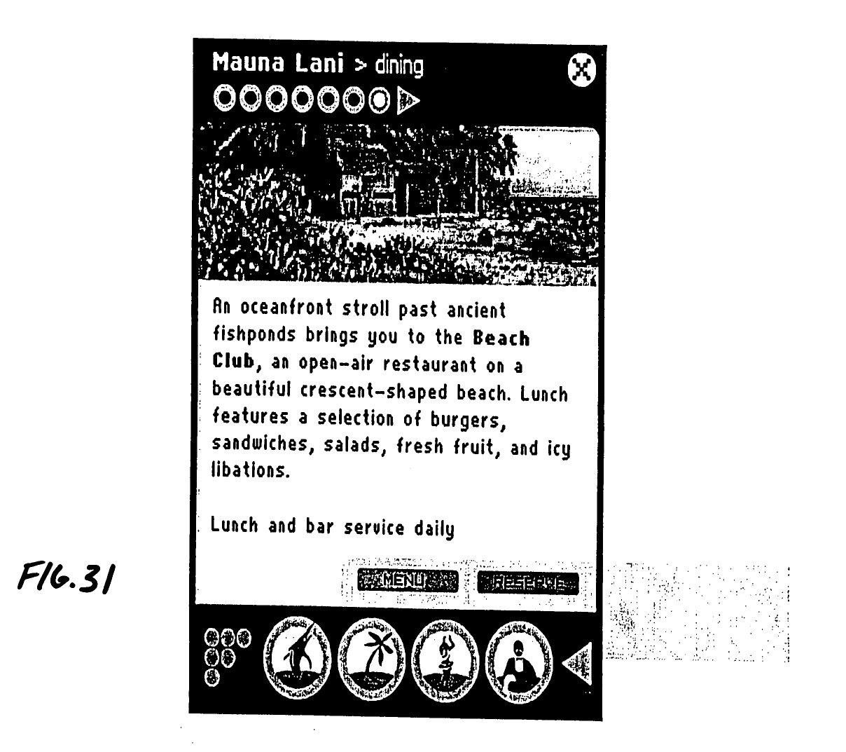

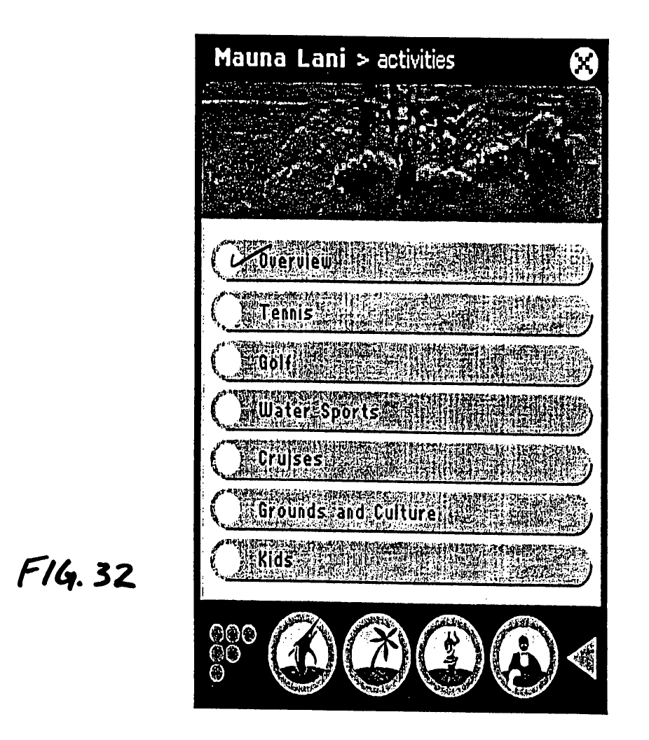

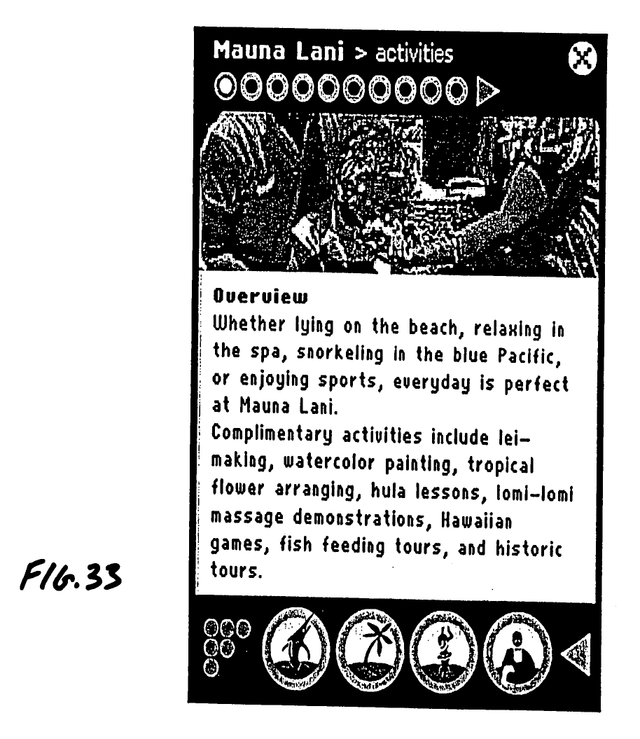

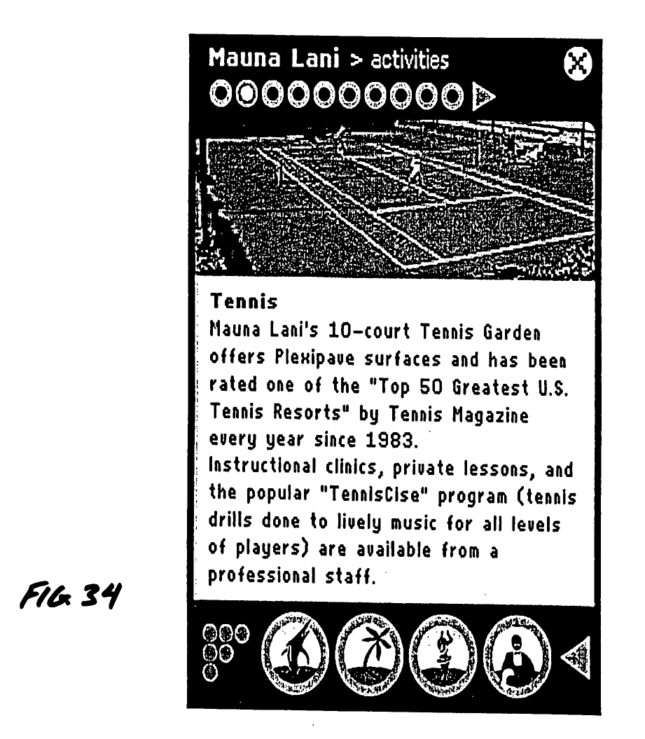

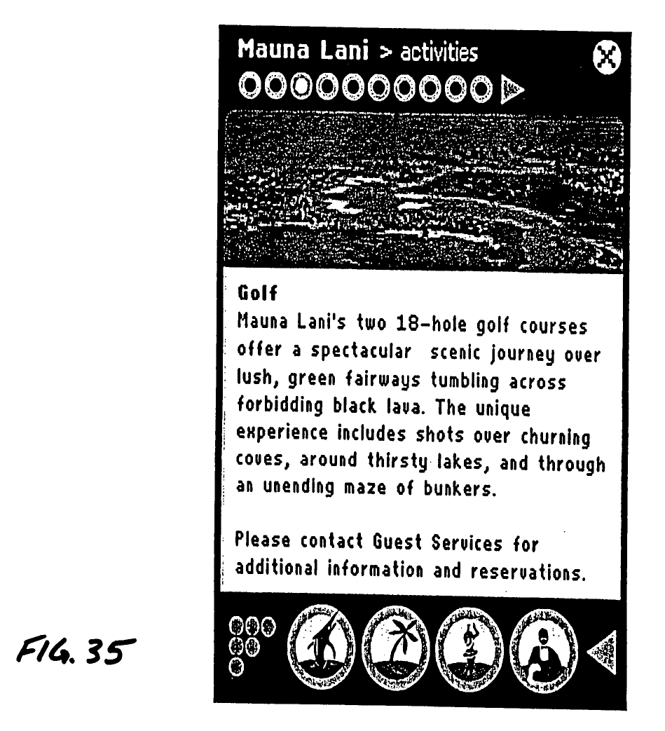

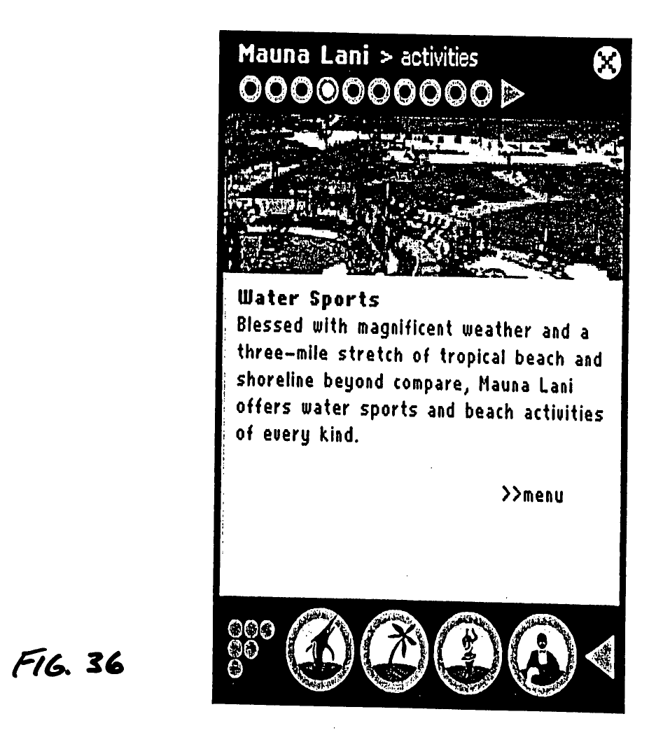

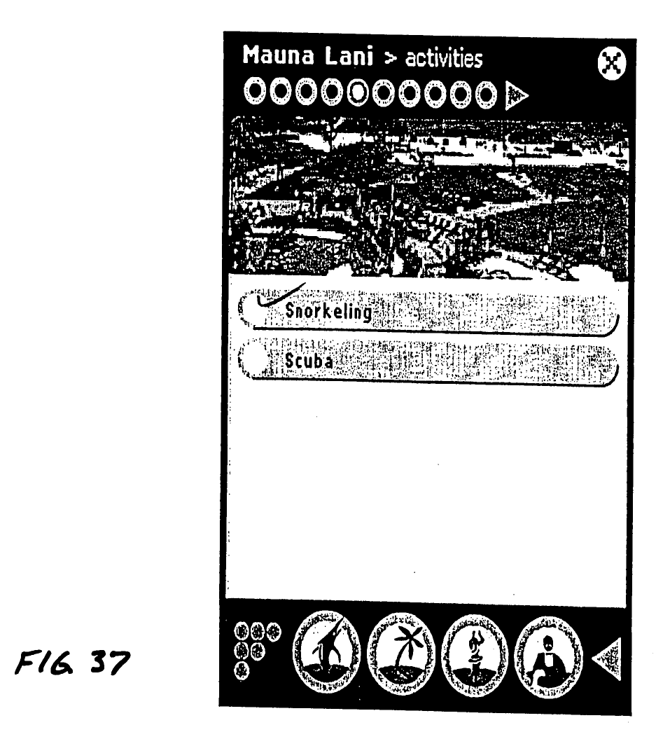

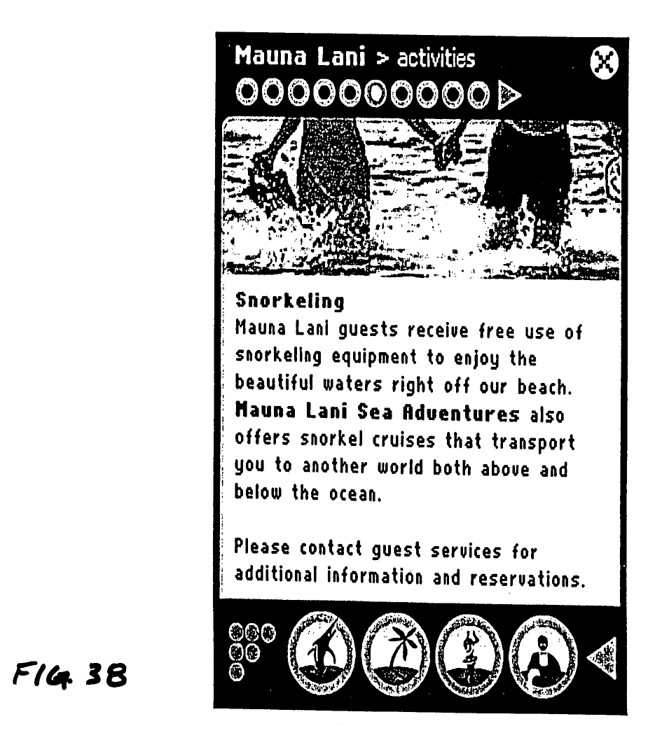

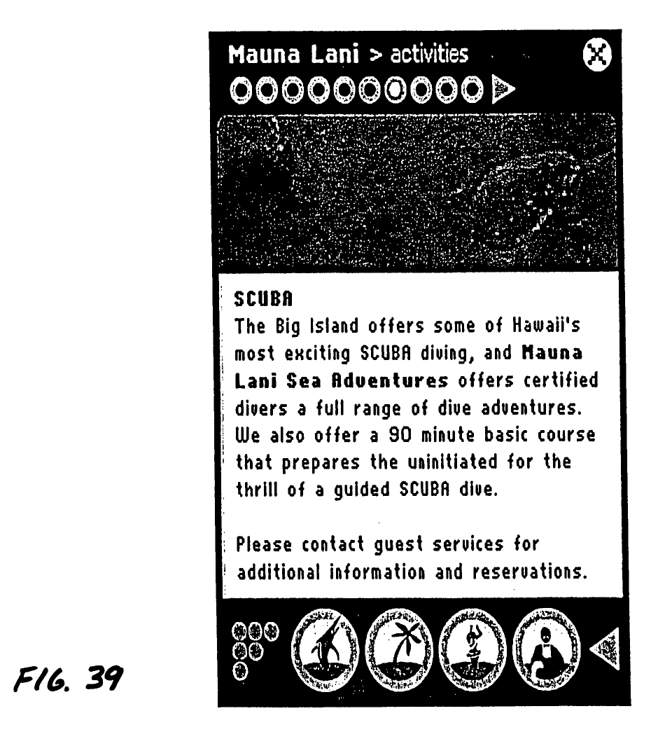

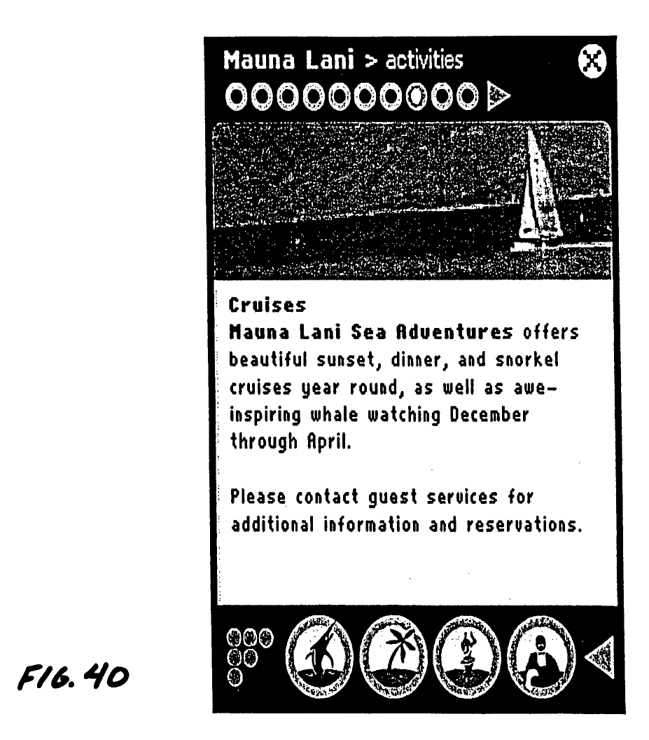

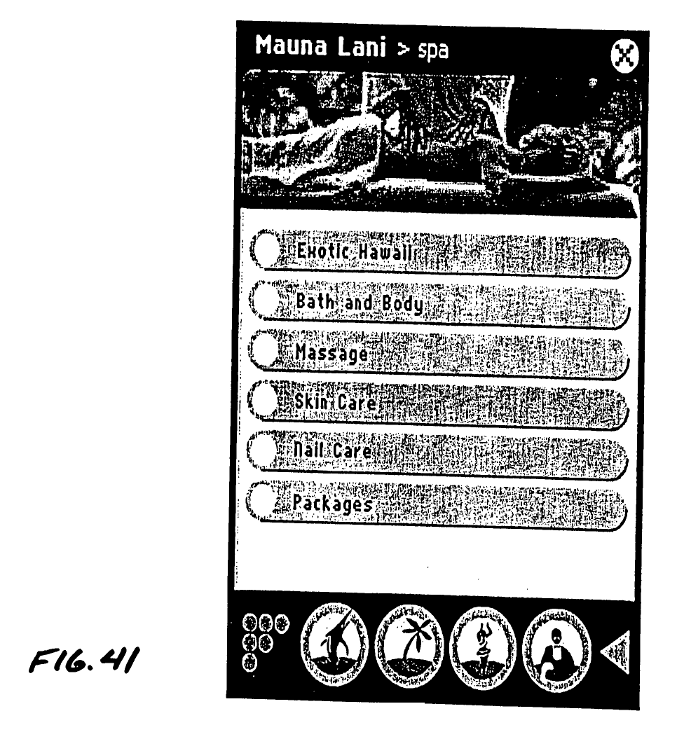

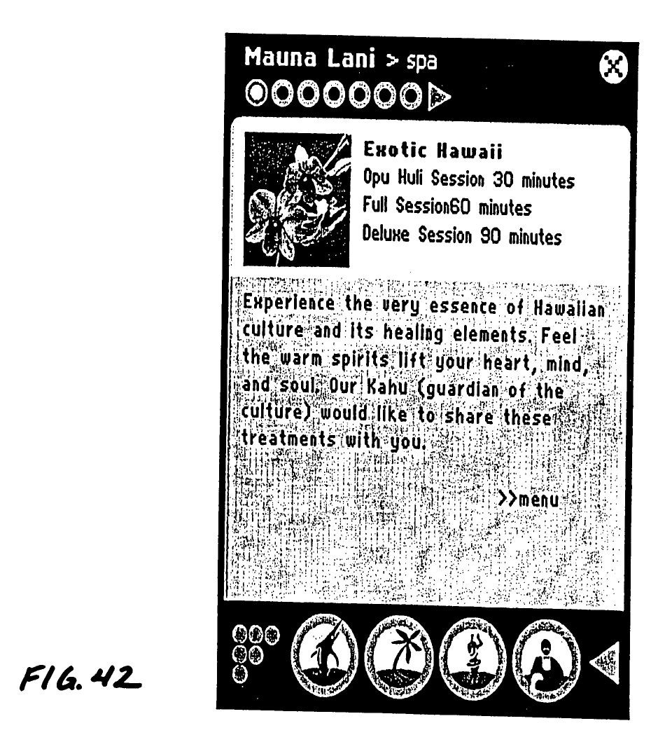

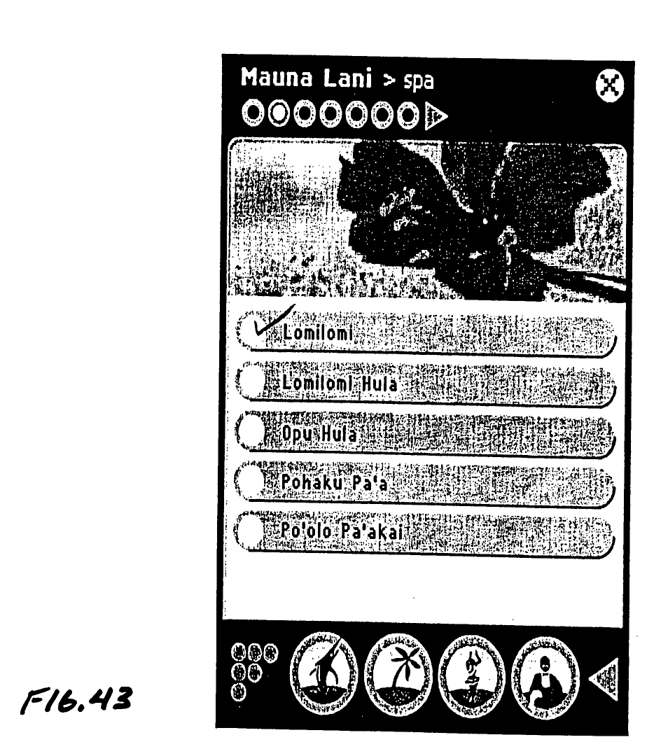

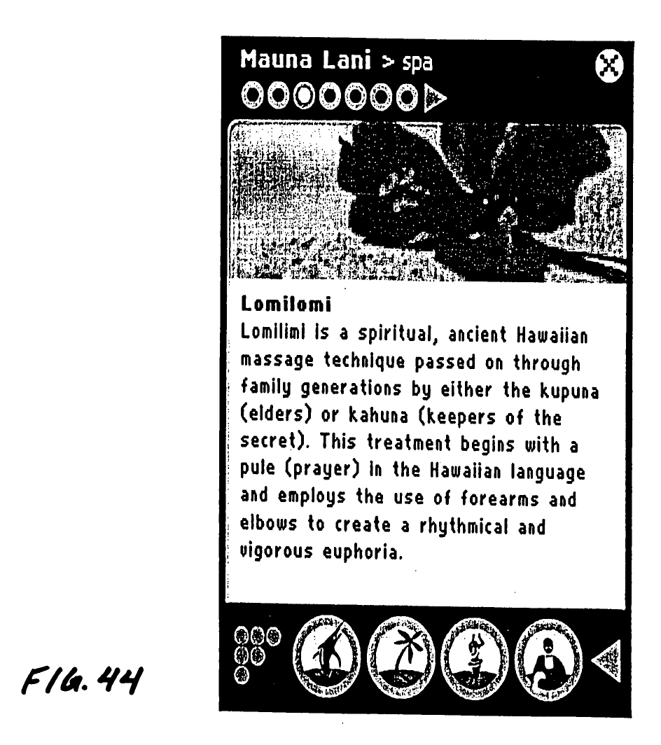

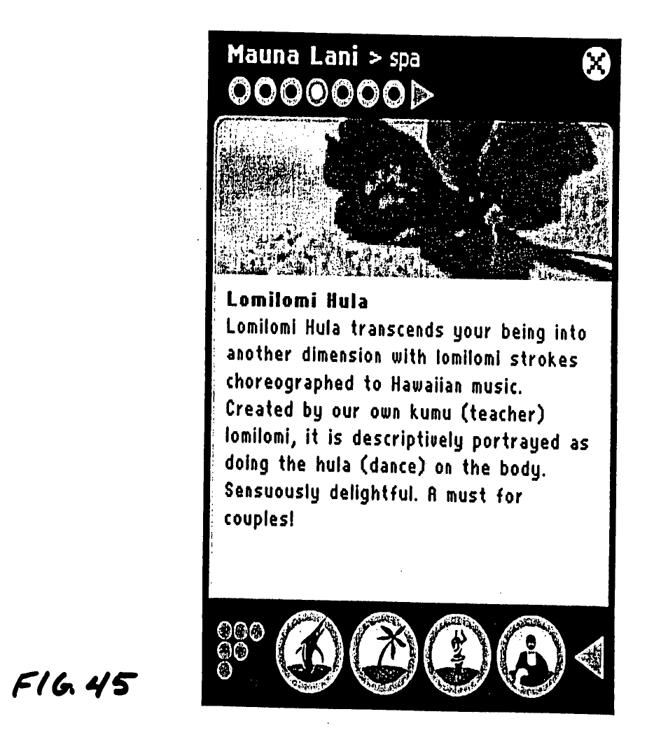

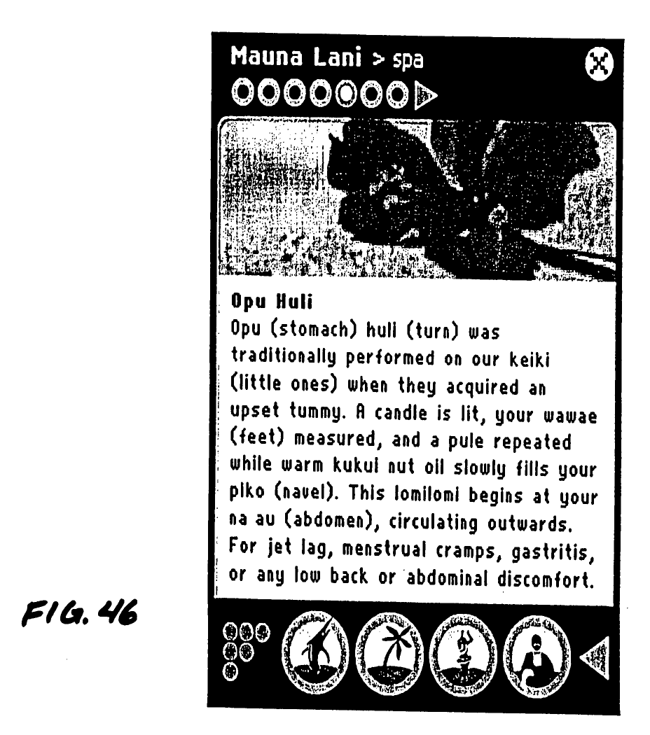

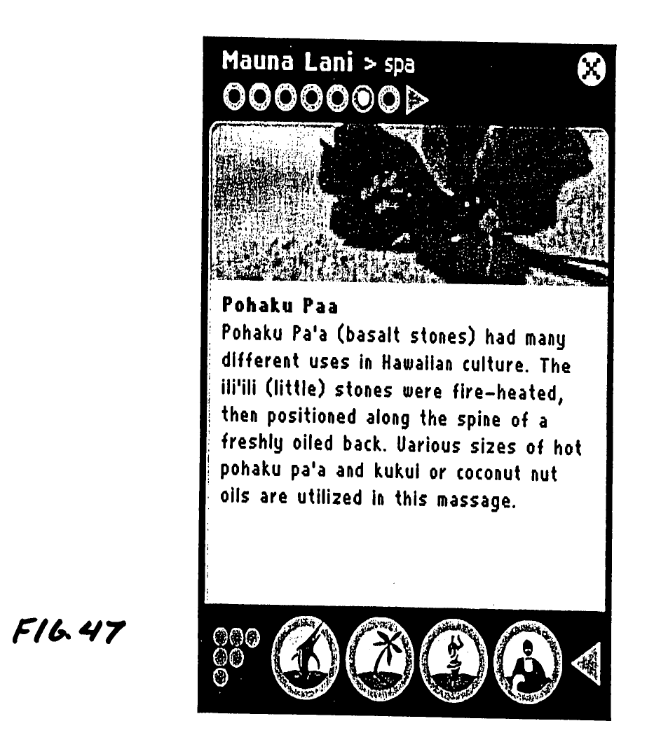

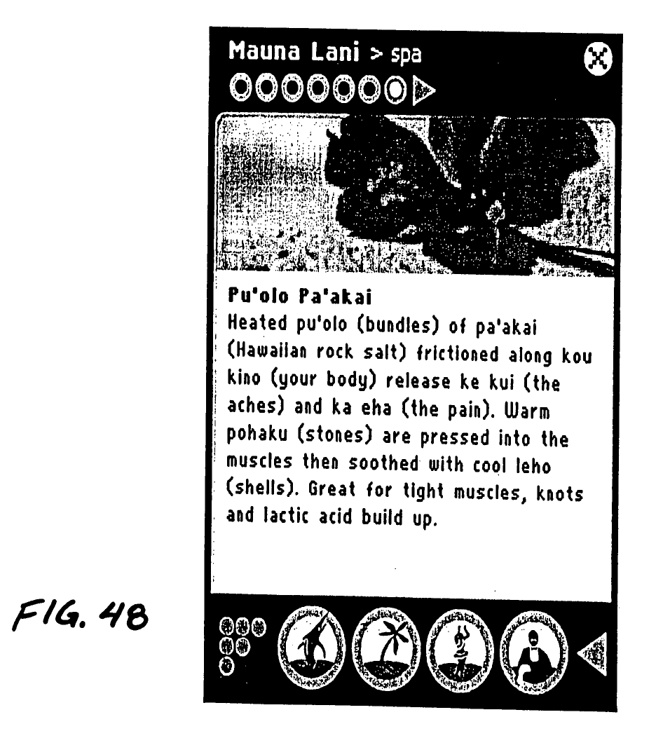

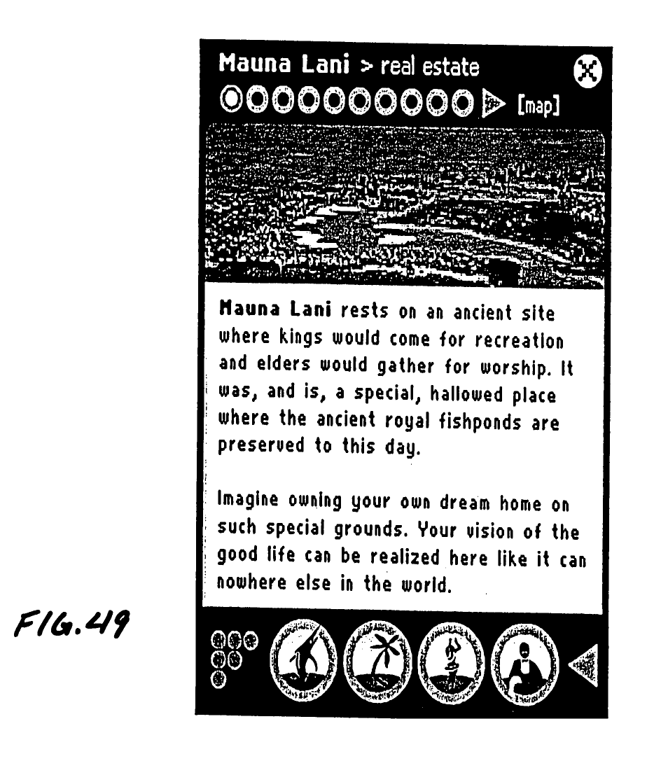

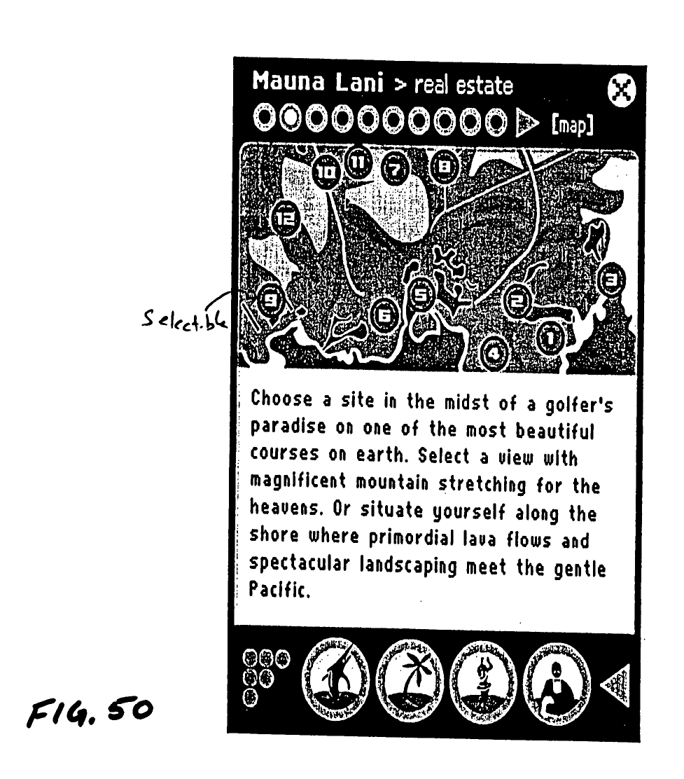

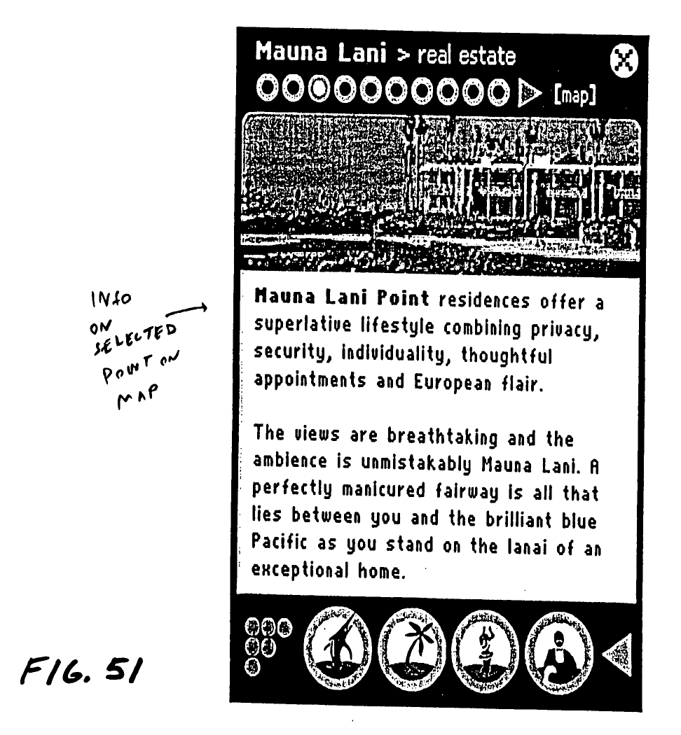

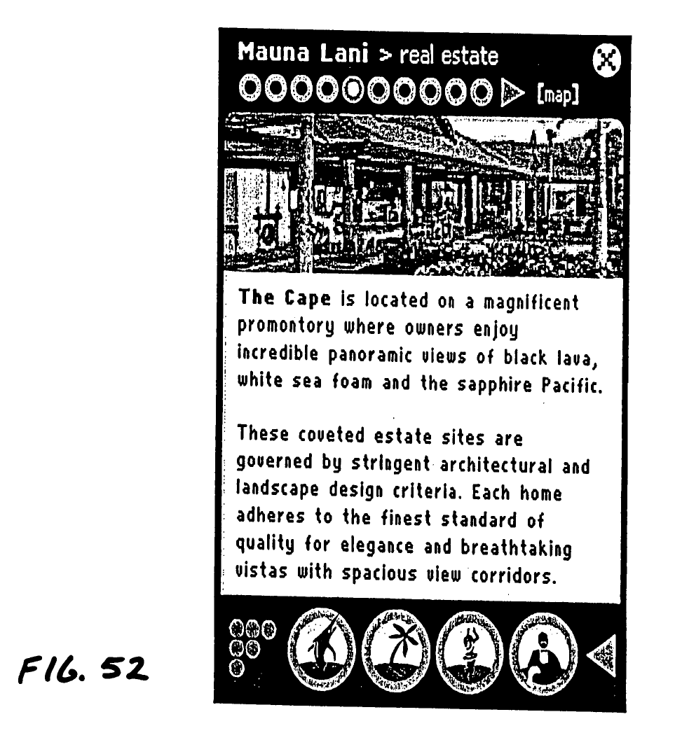

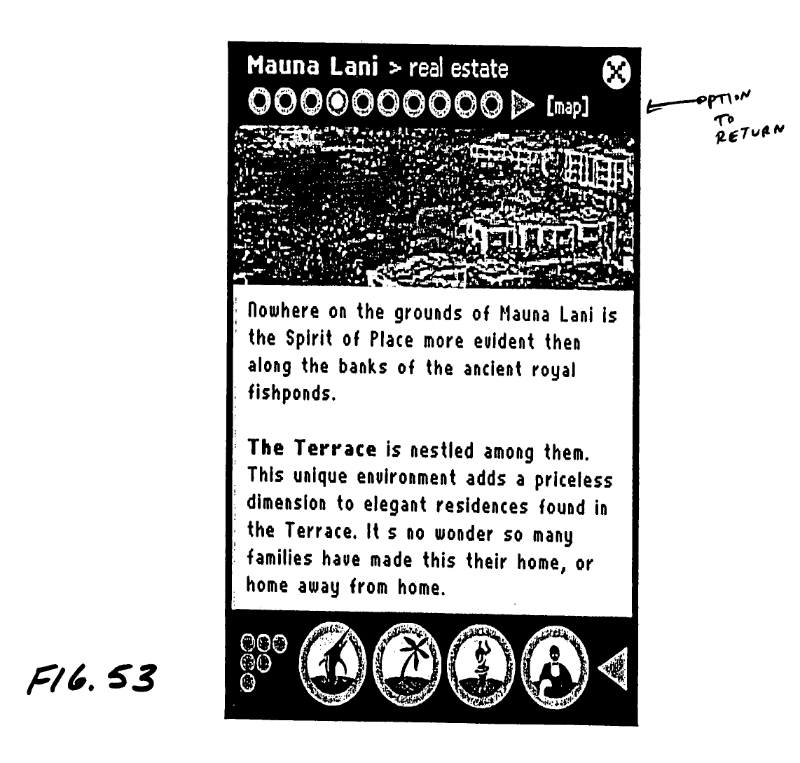

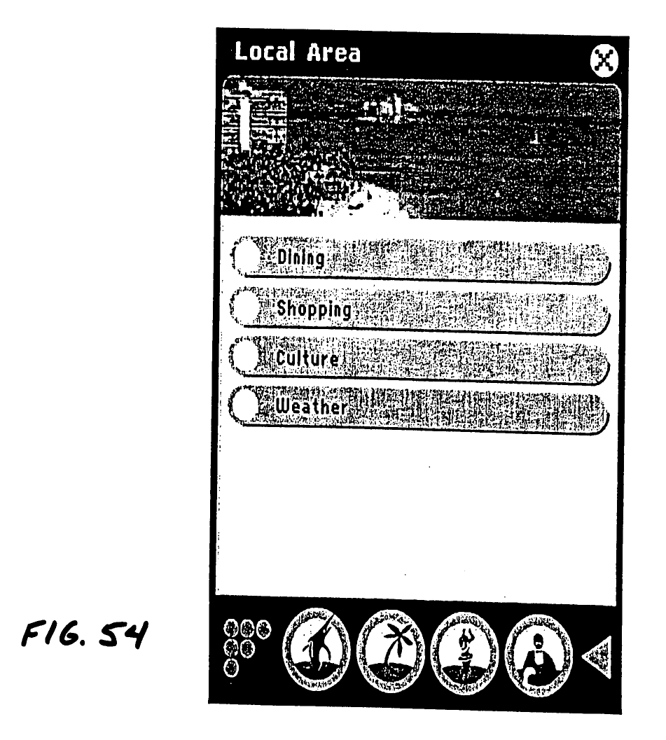

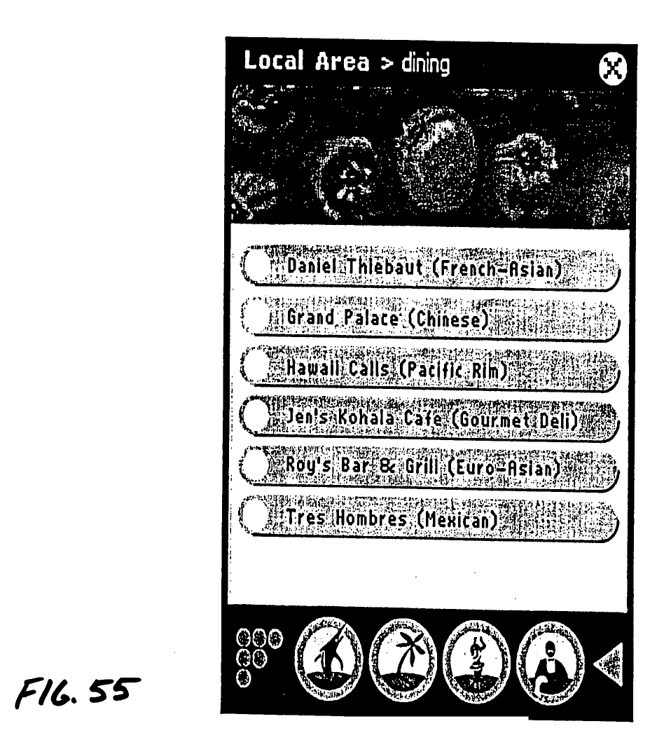

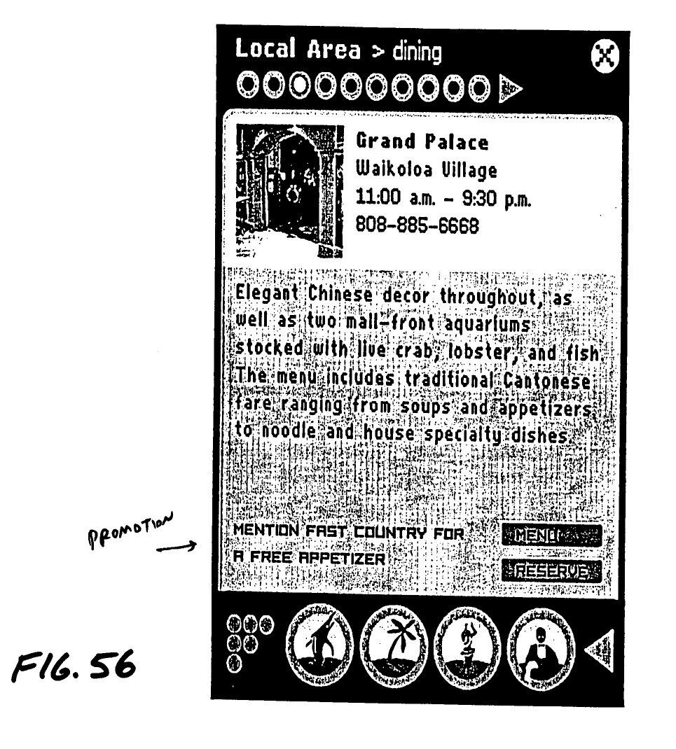

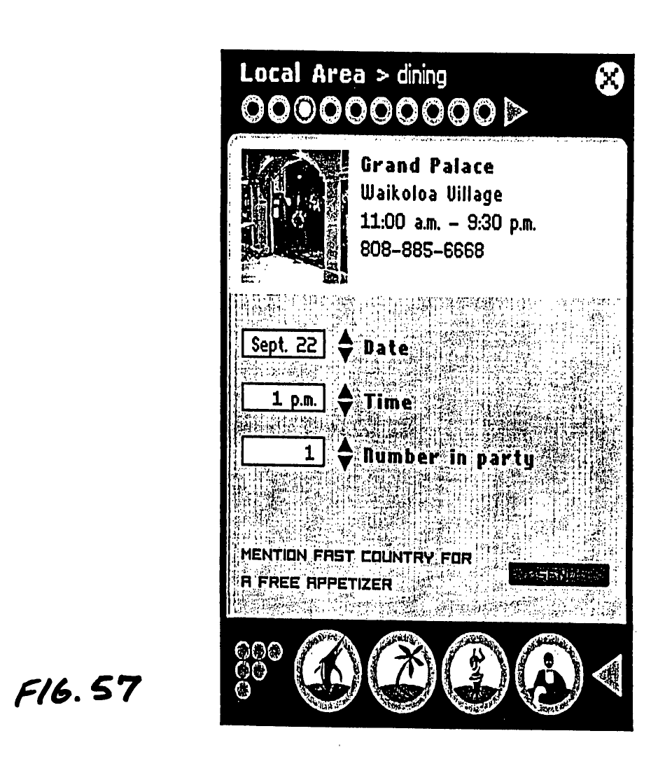

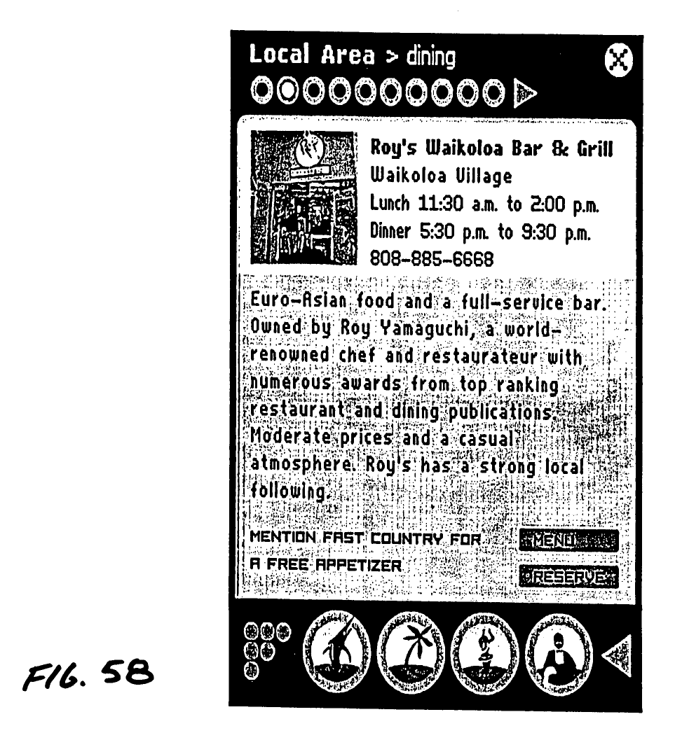

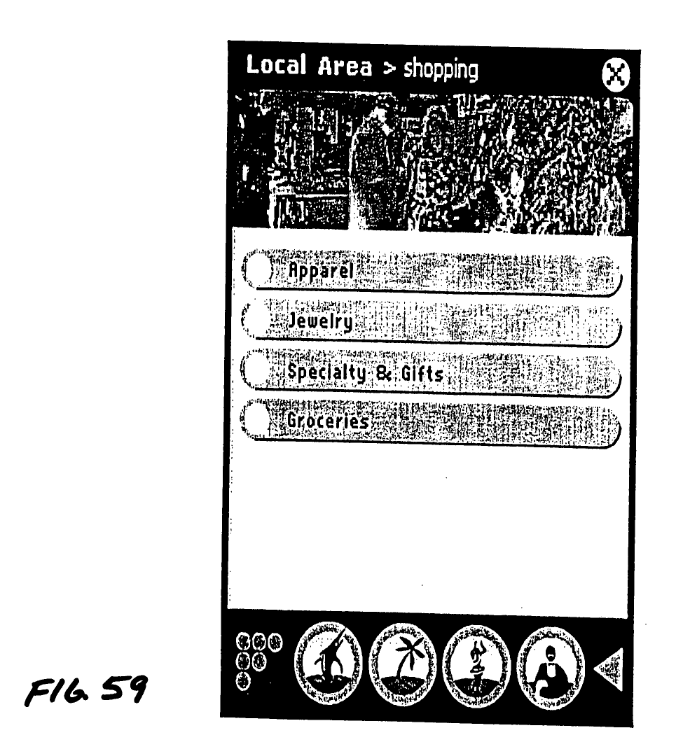

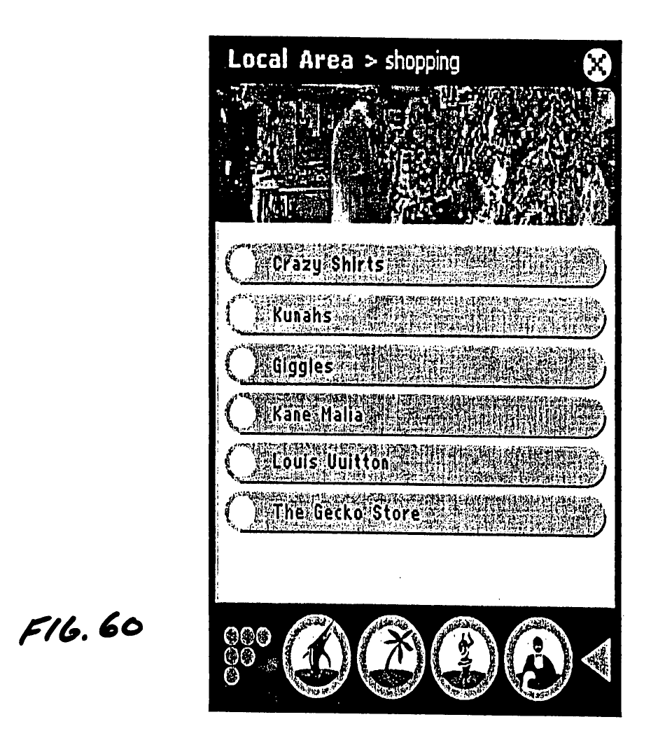

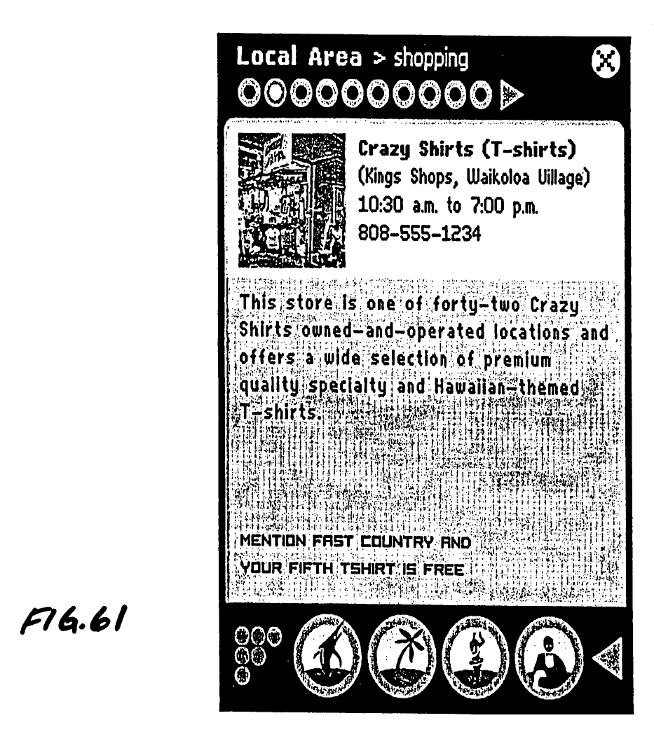

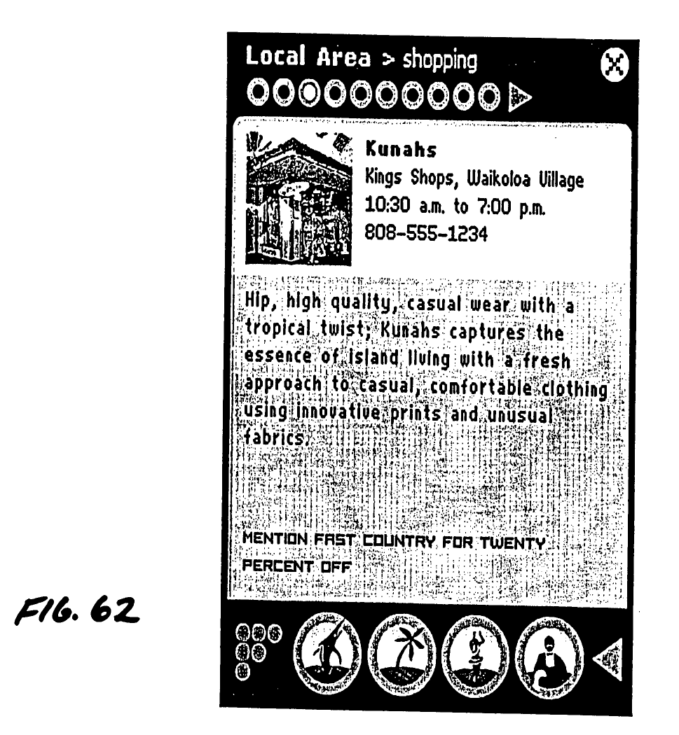

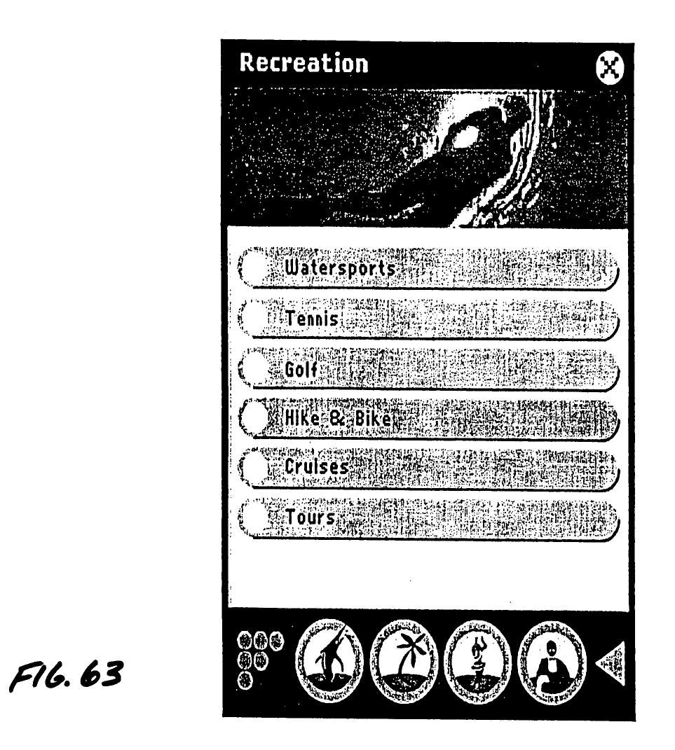

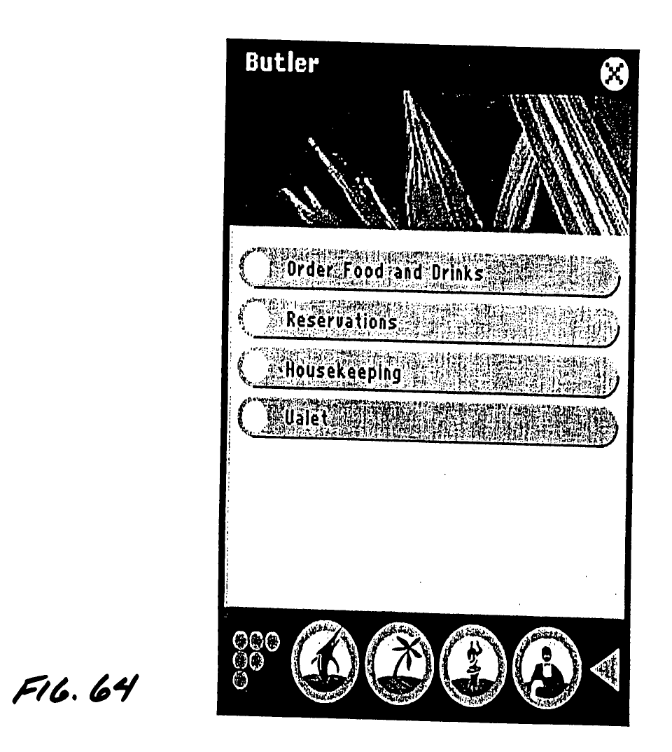

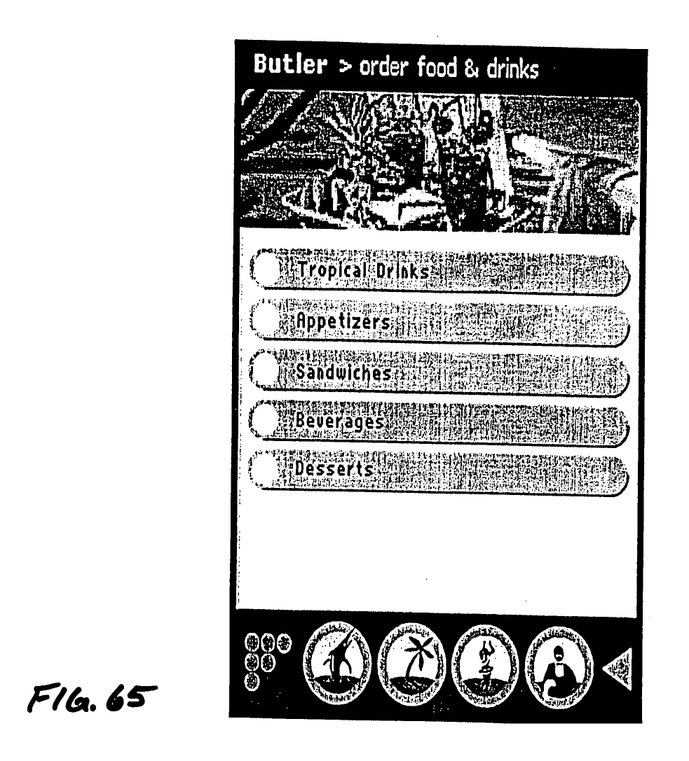

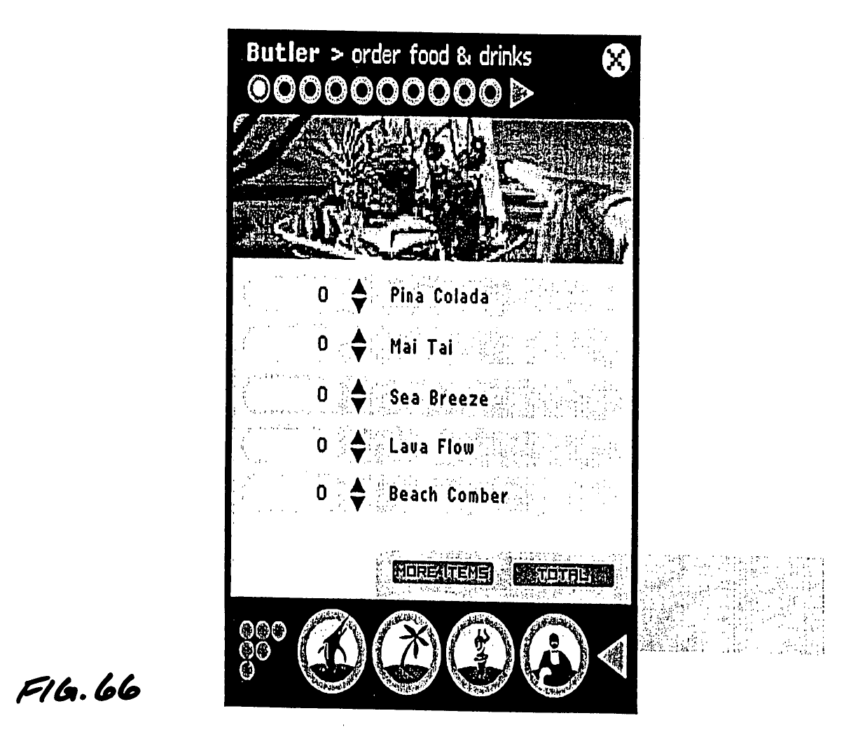

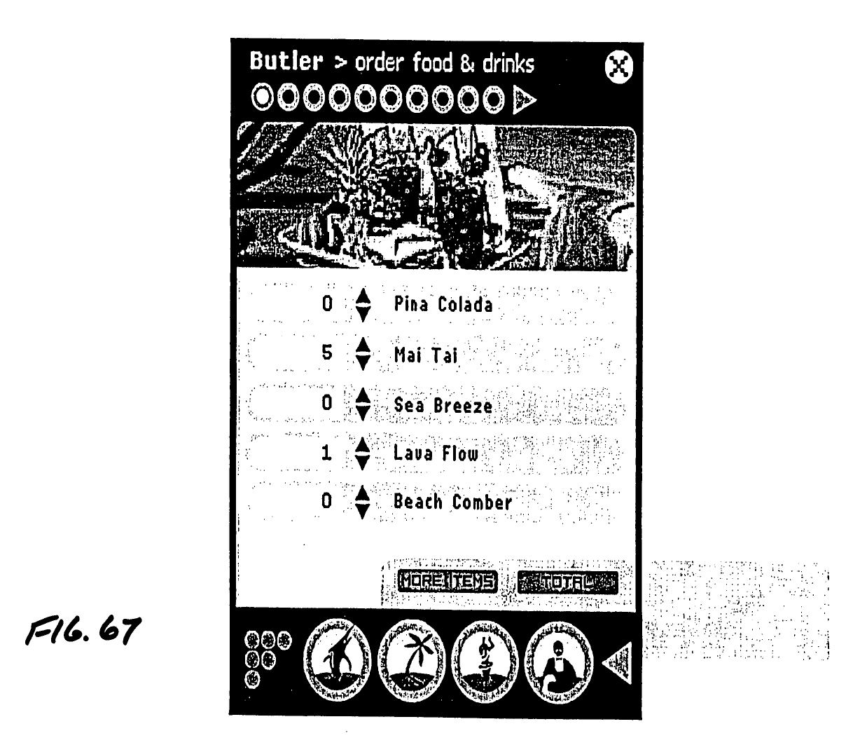

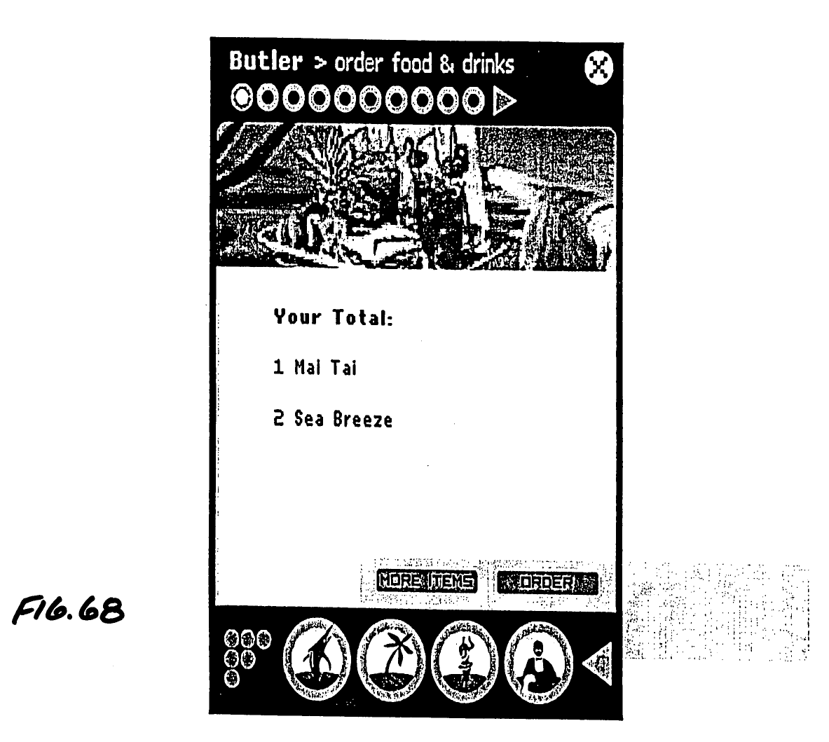

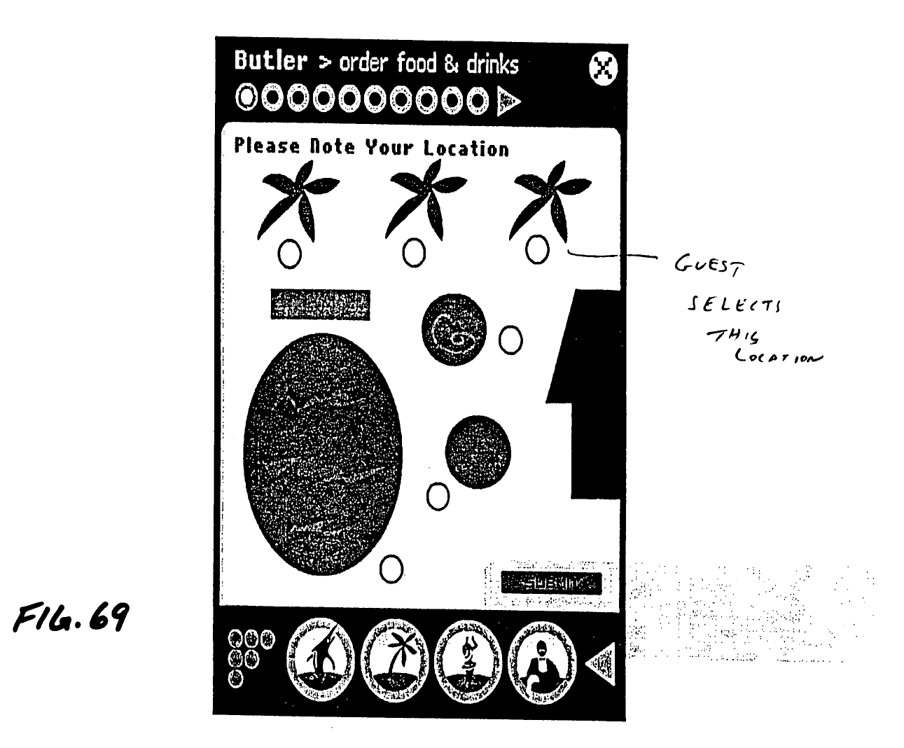

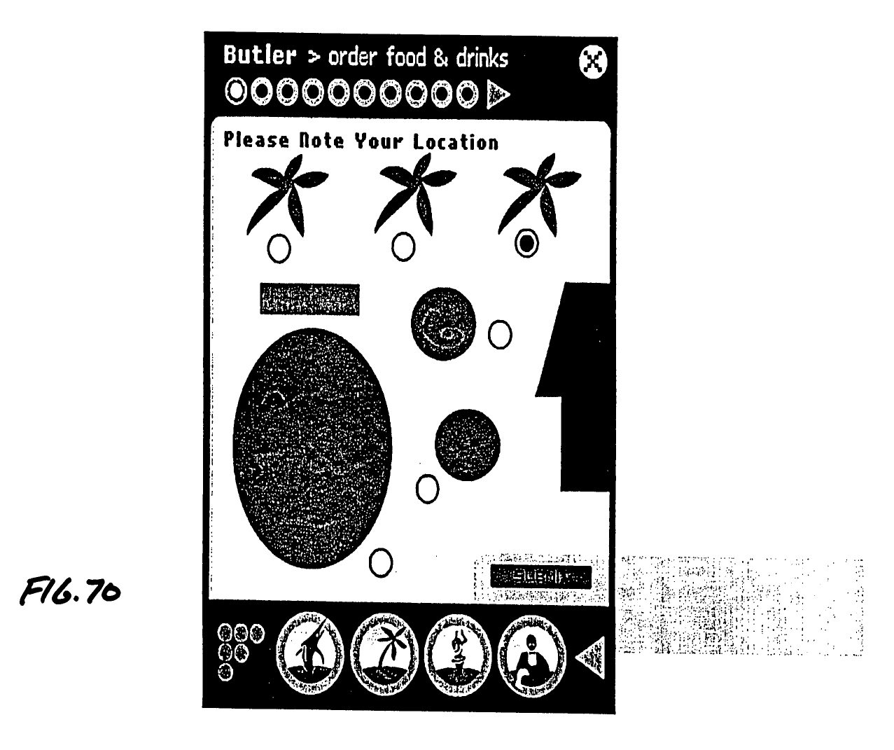

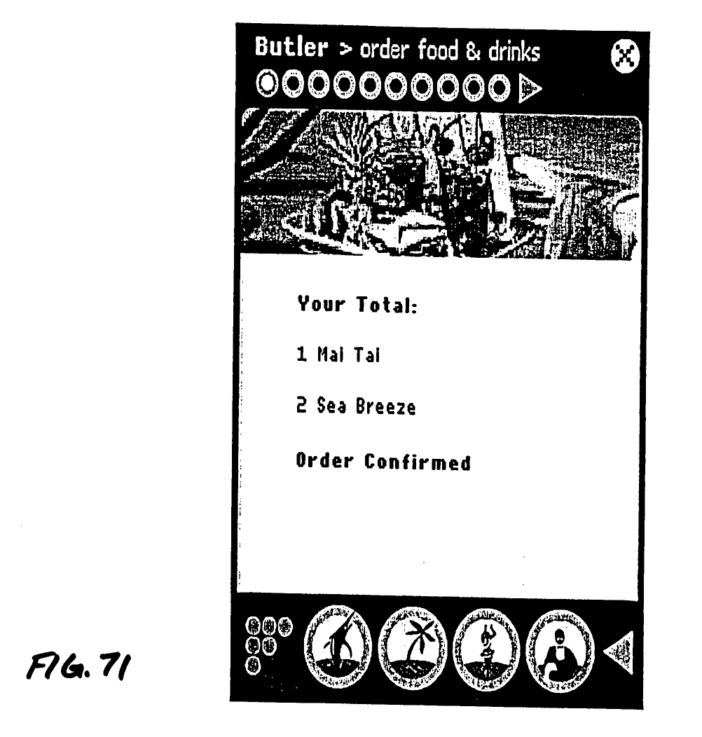

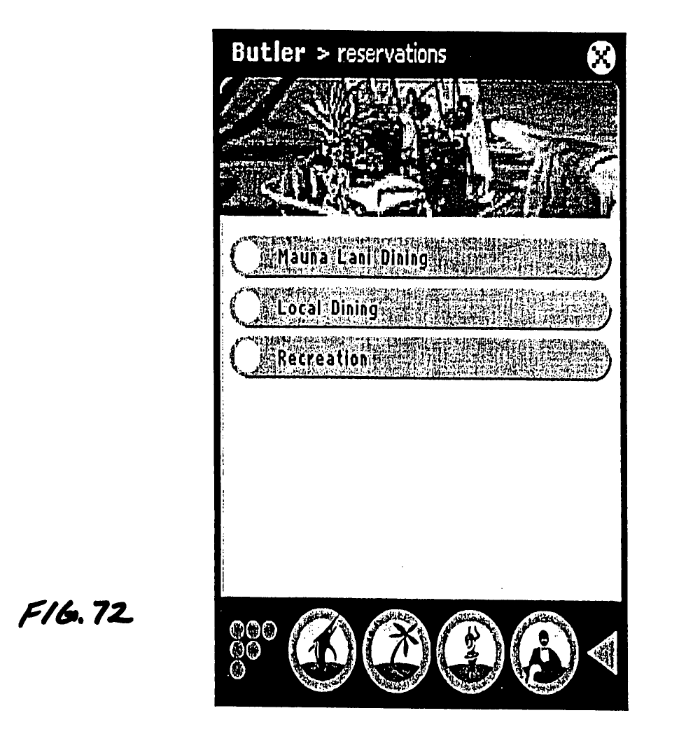

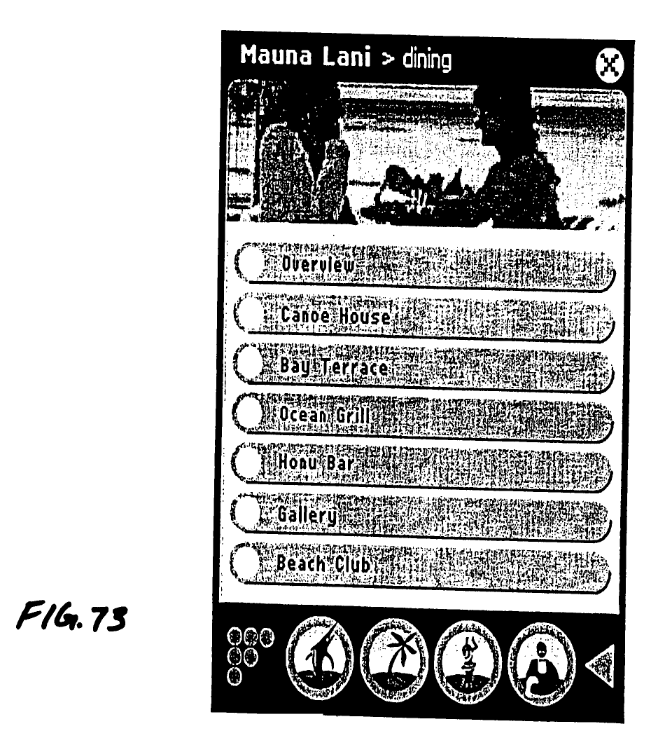

Illustrative techniques for implementing some of the guest resources illustratively mentioned herein are shown in FIGS. 20-73. FIGS. 20-73 show examples for presenting user resources, their supporting options or information, and other features to a guest through a graphical display of a portable WLAN communications device. Subject matter sought to be presented or further clarified will be understood by those skilled in the art in view of the illustrative features mentioned herein and the content of the figures. The displays are presented to a guest user using a certain tree arrangement that is evident from legends that are shown on the top of the displays. Notes have been inserted in some of the figures to further enhance the descriptions of the information presented in these figures.

It is to be understood that due to wide range of variations in hardware, software, or database structure that may be employed in implementing features illustratively described herein, in some implementations there may be an overlap in hardware, software, or database, or variations in configuration from what is specifically described herein.

A guest accommodations provider may typically provide accommodation for a transient guest. Such providers may include hotels, motels, resorts, cruise ships, trains, an all-inclusive spa, planes, etc.

If desired, a personal WLAN communications device may be adapted to operate with an optical scanner to provide further ease of use for guests (e.g., users can scan products which they wish to purchase).

A mobile wireless local area network communications device may for example be a Palm pilot, Pocket PC, Clie, or other handheld personal computing or communications devices that include or are adapted to include equipment for supporting WLAN communications. In addition, recent cellular telephones include WLAN equipment for providing WLAN communications capability when the telephone enters particular areas that have been configured to provide broadband services to the telephone via WLAN communications rather than through the wireless cellular network of the communications provider.

Further enhancements may be included that allows for updating or adapting to a new environment. In some situations such as when a user owns a portable WLAN communications device, features may be provided for the device to recognize that the device is within an environment in which guest resources are provisioned by a particular service provider. This may be recognized when the user previously used interactive guest resources that were provided by the same or a related service provider at a previous stay (for example, at a stay a different resort). For example, upon check-in, the user's device may be placed in a cradle and the device may detect the environment of service provider for which some platform already exists on the device and may automatically load the device with content for that stay.

In some embodiments, the system may include WLAN equipment and structures of facilities of the accommodations provider (e.g., restaurants, shops, health spa, gym, etc.). Thus, through various features described herein drawbacks of existing systems are alleviated and a guest stay with an accommodations provider is enhanced.

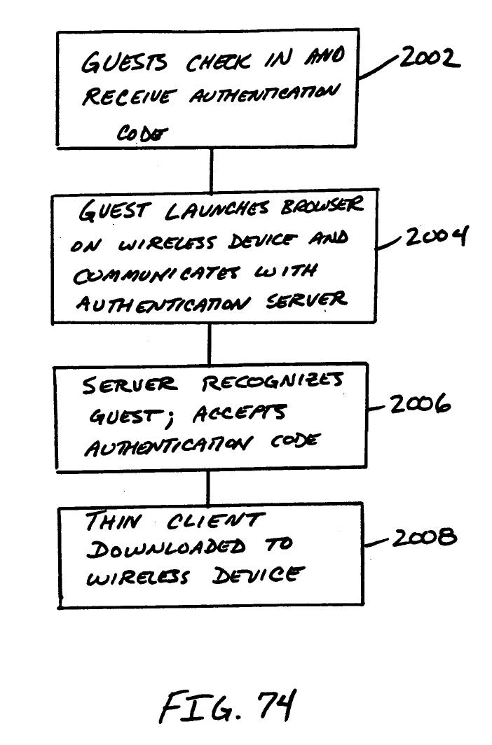

FIG. 74 illustrates another embodiment, wherein a resort companion service is deployed in the following manner. Guests check into the resort (or any type of deployment location) and receive an authentication code 2002. Using their own wireless-enabled device or one supplied by the deployment partner, the guest or end user launches a browser to communicate with an authentication server 2004 which may be accessible via the internet. The server recognizes the end user and accepts the authentication code 2006. The guest or user is then permitted to download a “thin client” 2008. The thin client is a small portion of the overall software program that permits initial functionality to occur. The thin client may be a Flash component (Flash software is distributed by Macromedia, Inc.), or other multimedia supported component. The user launches the client on the wireless device, and the services are dynamically delivered through it. Other portions of the client program may be downloaded as required when certain data requests are made by the user, or may automatically download in the background at a later time. For example, when a cellular telephone is used, all of the services may be accessed over the internet via the cellular providers system so that no local equipment or hardware is required.

It should also be understood that the guest or user may be permitted to download a “thick client”, which is the software program including a large portion, substantially all, or all of the functionality of the program. Alternately, the guest may be provided with the thick client on a smart card or memory stick device by a convention center, for example, which the guest can plug into her wireless device to enable her to interact with convention resources. Thus, the service can be distributed through a hardware device such as a portable storage chip or the like which may be capable of storing a large amount of data that could make presentation of a video or other multimedia presentation possible, for example.

This embodiment may include a Web-based version of the resort companion for registered users. In addition, the user interface may be customized to appear in a certain manner based on the type of user who signs in and the device that is being used. The user might even be an employee of the deployment partner who is using the resort companion for drink orders and the like. Although a Flash-based client-front end is used in the example above, it is contemplated that a Microsoft Corporation .NET CE (compact edition) version may be used. It is noted that certain portable device makers, such as the Palm Corporation, are releasing new software versions of their operating systems that will support a Flash plug-in, making it possible to deliver resort companion services to Palm OS-based devices in addition to Pocket PCs and other Windows CE devices.

It is also noted that high-bandwidth cellular networks are being developed and deployed and could be used to deliver the resort companion service without needing to install a WLAN for end user connectivity. The high-bandwidth cellular network can accommodate properly configured cellular telephones, some of which are known as “smartphones” which include an embedded operating system such as Microsoft Windows CE OS which can support digital, media-rich software system requirements. In such a system configuration, the WLAN component may be removed entirely or almost entirely.

The location-based services may be delivered based on a relationship the end user has with the deployment partner. In this case, someone “owns” the end user and this relationship establishes the type of services and content that the end user receives. This unique business model offers multiple revenue opportunities. For example, a resort hotel that deploys the system may sell advertising space to local stores. In addition, it may be possible to integrate certain services with systems or other services, such as concierge services with a booking system so that reservations can be made and confirmed and/or tickets provided, if required. It may also be possible to integrate the resort operational services with the property management system (PMS) of a hotel and point of sale (POS) systems, for example, and mobile-commerce shopping service with shopping cart and shipping mechanisms. In addition, push promotions may be used, wherein content is delivered to the wireless device directly without a request being made by a user. For example, a rotating icon may appear on the display screen of the user to indicate that a promotional message is available for viewing if she clicks on the icon.

An application of the system is software for convention attendees called the convention companion. The convention companion may be a superset of the resort companion, with the addition of convention-specific features, including floor maps, schedules, integrated calendaring, convention news, and the like. The convention companion may include a calendar of convention events that may automatically integrate with and update the calendar on the users wireless device with convention schedules, for example. The interactive convention companion may offer remotely managed, automatically updated, dynamic convention services delivered over Wi-Fi and the like. For such applications, the services deployed for the end user are not tied to accommodations. The end user may still be “owned” by the deployment partner so that a pre-established charge account is set up for the end user. In a resort deployment, the room account is used. For the convention companion, the attendee/end user establishes an account either before or upon arrival at the convention.

Each of the companion services described herein may include voice and video communication so that a user can, for example, communicate with the concierge or the like. In order to provide such voice and video communications, the Quality of Service (QOS) required of voice over internet protocol (VoIP) is not necessarily required.

Embodiments of the invention have been described. Nevertheless, it will be understood that various modifications may be made without departing from the spirit and scope of the invention. Accordingly, other embodiments are within the scope of the following claims.

What is claimed is:

1. A method for providing interactive user resources, comprising:
providing a wireless local area network (WLAN) including at least two access points that each provide at least a 300 foot radius of coverage located within a campus and at least one resources database;
providing each user with a unique identifier for use with a wireless device to access the resources database through the WLAN;
offering selectable content options on a display screen of the wireless device to users;
receiving a request for data based on a selected content option transmitted from the wireless device by a user; and
transmitting data from at least one resources database for display on the wireless device in response to the user request.

2. The method of claim 1 further comprising providing a communications connection to an external network.

3. The method of claim 2 wherein the external network includes at least one of a wide area network, an intranet, the internet, a cellular telephone network, or a public switched telephone network.

4. The method of claim 1 wherein the resources database includes at least one of restaurant information, a concierge database, a butler database, account information, local hospitality information, a gaming database, an activities database, a spa database, a messaging database, a meetings or events database, a transportation database, a promotional database, a communications database, a multimedia database, a personal planner or organizer database, a personnel database, and a map database.

5. The method of claim 1 wherein the campus includes at least one of the grounds of an accommodations provider, structures associated with an accommodations provider, a convention center, a casino, a spa, a resort, a cruise ship, a train or a plane.

6. The method of claim 5 wherein the structures include at least one of guest rooms, hotel lobbies, restaurants, casinos, concert halls, swimming pools, areas for recreational water activities, sports facilities, shops, spas, or garage areas.

7. The method of claim 1 further comprising providing an automatic locate feature that a user can access to find out his location on the campus.

8. The method of claim 7 wherein the location is provided by triangulation techniques, by identifying a current access point that is being used to communicate, by prompting the user to identify one of a plurality of selectable points displayed on a screen of the wireless device, by using a beacon signal generator associated with the wireless device, or by estimating the location of the user based on a roaming pattern.

9. The method of claim 1 wherein the wireless device is provided to a user by an accommodations facility and the database resources are made available for a predetermined amount of time.

10. The method of claim 1 wherein the wireless device is owned by the user and software is provided and loaded on the wireless device to enable the user to access the resources database for a predetermined amount of time.

11. The method of claim 10 further comprising providing software that permits the wireless device to automatically adapt to a new environment.

12. The method of claim 1 wherein the wireless device is at least one of a personal digital assistant, a pocket personal computer, a cellular telephone, a laptop computer, or a handheld device equipped to support WLAN communications.

13. The method of claim 1 wherein the WLAN is configured to adapt to the needs of a guest accommodations provider.

14. The method of claim 13 which further comprises a central resource of database, software, and information for an accommodations provider for the use of guests.

15. The method of claim 13 which further comprises providing a central interface to present a range of resources of guest accommodation providers.

16. The method of claim 1 further comprising providing at least one contention window-based communications device between at least one access point and the resource database to ensure prompt communications with the wireless devices.

17. The method of claim 16 wherein the communications device comprises local computer equipment having at least one of point-to-point or high speed communications connections to the WLAN to avoid latency issues.

18. The method of claim 1 further comprising providing at least one additional WLAN to handle an expected volume of requests from high traffic areas that include at least one of hotel lobbies, casinos, swimming pools, areas for recreational water activities, bars, and restaurants.

19. The method of claim 1 further comprising providing at least one additional WLAN to handle an expected volume of requests from low traffic areas that include at least one of guest rooms, hallways, shops, spas, parking or garage areas, and outdoor walking paths.

20. The method of claim 1 further comprising provisioning the wireless device with pertinent attendee personal information before the device is utilized by a conference attendee, wherein the attendee personal information enables an attendee to interact with at least one of conference planners and presenters, and enables the attendee to access at least one of professional intranets, portals and other content, or email.

21. The method of claim 1 wherein the unique identifier is at least one of a personal identification code, a pseudorandom code generated using a seed associated with a particular device, a code based on bio-authenticating techniques, an unseen device number associated with a device assigned to a user, an image of the user obtained through the portable WLAN device, data based on voice recognition, an user hotel room number, a credit card number, a debit card number, or an assigned identification code.

22. The method of claim 1 which further comprises providing transaction software to permit the user to transact financial activity through the WLAN.

23. The method of claim 22 which further comprises providing security measures including authentication software to prevent fraudulent transactions.

24. The method of claim 22 which further comprises providing financial software to enable the user to view his financial statement that includes at least one of a hotel room bill, a credit card, a debit card, or a credit line of the user.

25. The method of claim 1 which further comprises providing a software shell for the user that automatically adapts its options, display presentation and configuration based on at least one of the accommodations provider wherein the wireless device is currently located or an accommodations provider to which the user is traveling.

26. The method of claim 1 which further comprises providing two-way voice communications over the WLAN to enhance support resources.

27. The method of claim 26 which further comprises utilizing at least one of Voice over IP (VOIP) or video conferencing technology.

28. The method of claim 1 which further comprises implementing a platform on the WLAN that is configured to provide at least one of guest services, support transactions with resort staff, support transactions for purchase of branded merchandise, deliver locale-specific content and services, communicate with guests, provide temporary email and web access, deliver promotional material, or implement a temporary professional desktop.

29. The method of claim 1 which further comprises configuring the wireless device as a host for an imaging device.

30. The method of claim 1 which further comprises provisioning the wireless device with an application shell that includes at least one of images or graphics for presentation to the user.

31. The method of claim 30 wherein the application shell loads content from a central applications server.

32. The method of claim 1 which further comprises streaming media from a media server in response to the user request.

33. A computer program product stored on a computer readable medium for providing interactive user resources, the computer program comprising instructions operable to cause a computer to:
offer selectable content options on a display screen of a wireless device over a wireless local area network (WLAN);
receive and recognize a unique user identifier along with a request for data based on a selected content option transmitted from the wireless device by a user; and
transmit data from at least one resources database for display on the wireless device of the user in response to the user request.

34. The computer program product of claim 33, further comprising instructions operable to cause a computer to transmit data that includes at least one of restaurant information, concierge data, butler data, account information, local hospitality information, gaming data, activities data, spa data, messaging data, meetings or events data, transportation data, promotional data, communications data, a personal planner or organizer data, personnel data, and map data.

35. The computer program product of claim 33, further comprising instructions operable to cause a computer to provide an automatic locate feature that a user can access to find out his location on a campus.

36. The computer program product of claim 33, further comprising instructions operable to cause a computer to permit a wireless device to automatically adapt to a new environment.

37. The computer program product of claim 33, further comprising instructions operable to cause a computer to provide a central interface to present a range of resources of guest accommodation providers to a user on the display of the wireless device.

38. The computer program product of claim 33, further comprising instructions operable to cause a computer to provide the wireless device with pertinent attendee personal information before the device is utilized by a conference attendee, wherein the attendee personal information enables an attendee to interact with at least one of conference planners and presenters, and enables the attendee to access at least one of professional intranets, portals and other content, or email.

39. The computer program product of claim 33, further comprising instructions operable to cause a computer to permit the user to transact financial activity through the WLAN.

40. The computer program product of claim 39, further comprising instructions operable to cause a computer to provide security measures including authentication requirements to prevent fraudulent transactions.

41. The computer program product of claim 39, further comprising instructions operable to cause a computer to enable the user to view his financial statement that includes at least one of a hotel room bill, a credit card, a debit card, or a credit line of the user.

42. The computer program product of claim 33, further comprising instructions operable to cause a computer to provide two-way voice communications over the WLAN to enhance support resources.

43. The computer program product of claim 33, further comprising instructions operable to cause a computer to provision the wireless device with an application shell that includes at least one of images or graphics for presentation to the user.

44. A method for providing interactive user resources, comprising:
providing a user with an authentication code for use with a wireless device;
providing an authentication server that can be accessed by the wireless device and that can authenticate the authentication code; and
downloading a thin client to the wireless device after the authentication code has been recognized which generates an user interface display that includes a plurality of selectable options representing the user resources.

45. The method of claim 44 which further comprises launching the thin client to dynamically receive data or services.

46. The method of claim 44 wherein the data or services offered to the user are controlled by a deployment partner.

47. The method of claim 44 wherein the authentication server can be accessed via the internet.

48. The method of claim 47 wherein registered users can access the authentication server without an authentication code.

49. The method of claim 44 wherein the user interface may be customizable.

50. The method of claim 44 wherein the wireless device is a cellular phone.

51. The method of claim 44 wherein the user resources are controlled by at least one of a resort company, a convention center, an accommodations provider, a casino, a spa, a cruise ship line, a railroad company, an airline or other organization.

52. A computer program product stored on a computer readable medium for providing interactive user resources, the computer program comprising instructions operable to cause a computer to:
provide a user with an authentication code for use with a wireless device for permitting access to an authentication server; and
download a thin client to the wireless device after the authentication code has been recognized which generates an user interface display that includes a plurality of selectable options representing the user resources.

53. The computer program product of claim 52, further comprising instructions operable to cause the wireless device to launch the thin client to dynamically receive data or services.

54. The computer program product of claim 52, further comprising instructions operable to cause the wireless device to access the authentication server via the internet.
